(19) United States
(12) Patent Application Publication
(10) Pub. No.: US 2015/0242855 A1
(43) Pub. Date: Aug. 27, 2015

(54) SYSTEMS AND METHODS OF IMAGE PROCESSING AND VERIFICATION FOR SECURING FUEL TRANSACTIONS

(71) Applicant: FUEL VISION LTD., RaAnana (IL)

(72) Inventor: Yoav VILNAI, Tel-Aviv (IL)

(73) Assignee: FUEL VISION LTD., RaAnana (IL)

(21) Appl. No.: 14/708,261

(22) Filed: May 10, 2015

Related U.S. Application Data
(63) Continuation-in-part of application No. PCT/IL2013/050940, filed on Nov. 13, 2013.
(60) Provisional application No. 61/725,640, filed on Nov. 13, 2012.

(51) Int. Cl. G06Q 20/40; G06F 17/30; G05B 15/02; G06T 7/00; F02M 59/00; G06Q 50/06; H04N 7/18

(52) U.S. Cl. CPC G06Q 20/40; G06Q 50/06; G06F 17/30247; H04N 7/183; G06T 7/001; F02M 59/00; G05B 15/02; G06T 2207/30232

(57) ABSTRACT

A fuel inlet monitoring system comprising at least one remote recognizer device and at least one processing application, wherein the at least one remote recognizer device collects data regarding a fuel delivery nozzle and a vehicle fuel tank inlet and the processing application analyzes information created by the at least one recognizer device to generate at least one signal upon detecting at least one of the fuel delivery nozzle not inserted inside the vehicle fuel tank inlet and the fuel delivery nozzle inserted inside the fuel tank inlet of the vehicle.

### CROSS-REFERENCE TO RELATED APPLICATIONS

This application is a continuation-in-part of international application PCT/IL2013/050940 filed Nov. 13, 2013, the contents of which are incorporated herein by reference in their entirety.

This application claims the benefit of priority under 35 USC §119(e) of U.S. Provisional Patent Application No. 61/725,640 filed Nov. 13, 2012, the contents of which are incorporated herein by reference in their entirety.

### FIELD AND BACKGROUND OF THE INVENTION

In general, the present invention pertains to the art of image processing and verification. In particular, the invention relates to systems and methods of image processing and verification for a purchase authorization associated with fuel dispensing.

The present invention, in some embodiments thereof, relates to image recognition and processing and, more particularly, but not exclusively, to image recognition and processing for purchase authorization associated with fuel dispensing.

### BACKGROUND ART INCLUDES

U.S. Pat. No. 6,082,618 to Brown discloses a multi-product dispenser system including a pump computer having a software program. A motor-valve drive board is coupled to the pump computer. A sales display is also coupled to the pump computer as is an optional preset. A hardware identifier in each of the computer, motor-valve drive board, sales display and optional preset, is provided to communicate with the software program in the pump computer.

U.S. Pat. No. 7,481,366 to Demere discloses systems and methods for remote authorization of fuel dispensing and authorization or confirmation of participation in frequent shopper programs, club memberships, and the like. In one embodiment, identification documents may be used as membership cards for a retailer's membership or frequent shopper program. In another embodiment, an identification may be a membership card to gain access to a retailer. In another aspect, an identification document may be coupled with one or more PINs to validate a customer, or optionally, the one or more PINs can be used instead of the identification document to validate a customer.

U.S. 2008/0040287 A1 to Harrell, et al., discloses systems and processes that may provide for managing a fuel dispenser. In particular implementations, a system and process for a fuel dispenser may include the ability to receive at least a portion of transaction data for a fueling session, determine whether at least a portion of the received transaction data requires a security measure, and, if at least a portion of the received transaction data requires a security measure, apply a security measure to at least a portion of the received transaction data.

U.S. 2006/0269105 A1 to Langlinais discloses an apparatus and methods for obtaining an image of a license plate mounted on a moving vehicle. The methods includes determining, exposure for the image capture based on a meter reading that places greater weight on the license plate portion of the field, than on any portions of the field of view in which the license plate is not positioned. The method also includes adjusting settings for the image capture device based on the meter reading while holding device shutter speed fixed, and then capturing an image of the field of view. The image capture device is adjusted to have a fixed shutter speed appropriate for the speed of the moving vehicle, and its automatic adjustments are based on a meter reading that places greater weight on the license plate portion of the field of view.

U.S. 2012/0155712 A1 to Paul, et al, discloses a method for determining a confidence level to be used in identifying a vehicle. The method includes receiving a vehicle image, extracting a license plate image from the at least one vehicle image, determining a license plate number and associated confidence level based upon the license plate image, and comparing the associated confidence level against a confidence threshold. If the associated confidence level is below the confidence threshold, the method further includes extracting auxiliary data from the at least one vehicle image, corresponding the extracted auxiliary data and a set of stored auxiliary data, and updating the associated confidence level to produce an updated confidence level based upon the correspondence of the extracted auxiliary data and the set of stored auxiliary data.

Additional background art includes U.S. Pat. No. 5,890,136 to Kipp, U.S. Pat. No. 5,913,180 to Ryan, U.S. Pat. No. 6,098,879 to Terranova, U.S. Pat. No. 6,116,505 to Withrow, U.S. Pat. No. 6,131,811 to Gangi, U.S. Pat. No. 6,254,005 to Smith et al., U.S. Pat. No. 6,293,462 to Gangi, U.S. Pat. No. 6,402,029 to Gangi, U.S. Pat. No. 6,422,464 to Terranova, U.S. Pat. No. 6,522,947 to Hartsell, Jr., U.S. Pat. No. 6,612,488 to Suzuki, U.S. Pat. No. 6,647,372 to Brady et al., U.S. Pat. No. 6,854,642 to Metcalf et al., U.S. Pat. No. 6,938,821 to Gangi.

### SUMMARY OF THE INVENTION

An aspect of some embodiments of the present invention relates to image recognition and processing for purchase authorization associated with fuel dispensing.

According to an aspect of some embodiments of the present invention there is provided a fuel inlet monitoring system comprising at least one remote recognizer device and at least one processing application, wherein the at least one remote recognizer device collects data regarding a fuel delivery nozzle and a vehicle fuel tank inlet and the processing application analyzes information created by the at least one recognizer device to generate at least one signal upon detecting at least one of the fuel delivery nozzle not inserted inside the vehicle fuel tank inlet and the fuel delivery nozzle inserted inside the fuel tank inlet of the vehicle.

According to some embodiments of the invention, the at least one remote recognizer device comprises an imaging device and the at least one processing application comprises an image processing application.

According to some embodiments of the invention, the at least one signal is generated upon detecting the fuel delivery nozzle is not inserted inside the fuel tank inlet of the vehicle.

According to some embodiments of the invention, the at least one signal is generated upon detecting the fuel delivery nozzle is inserted inside the fuel tank inlet of the vehicle.

According to some embodiments of the invention, the at least one imaging device comprises an existing camera in a vehicle fueling service station.

According to some embodiments of the invention, the at least one imaging device comprises a camera specially used in the vehicle fueling service station as part of the fuel inlet monitoring system.

According to some embodiments of the invention, the at least one imaging device comprises a handheld camera.

According to some embodiments of the invention, the at least one imaging device is positioned to provide images of the fuel delivery nozzle.

According to some embodiments of the invention, the at least one imaging device comprises a plurality of cameras each providing at least one image.

According to some embodiments of the invention, at least one camera of the plurality of cameras is located to the side of the vehicle.

According to some embodiments of the invention, at least one camera of the plurality of cameras is located above the vehicle.

According to some embodiments of the invention, the fuel inlet monitoring system further comprises a database containing information about at least one of vehicle models, general service station layouts, specific authorized vehicles, specific operators of vehicles and specific service stations.

According to some embodiments of the invention, the database further comprises profiles containing information on at least one of the vehicle and the vehicle operator.

According to some embodiments of the invention, the profiles of individual vehicles further comprises information comprising at least one of the vehicle's fuel inlet location, the vehicle's color and the vehicle's shape.

According to some embodiments of the invention, the database is stored on at least one remote computer accessible by a plurality of fuel service stations.

According to some embodiments of the invention, the fuel inlet monitoring system comprises circuitry which detects whether a fuel delivery nozzle that was previously detected as being inserted inside the vehicle fuel inlet is no longer inserted inside the vehicle fuel inlet.

According to some embodiments of the invention, an alert signal is generated when the fuel inlet monitoring system detects that a fuel delivery nozzle that was previously detected as being inserted inside the vehicle fuel inlet is no longer inserted inside the vehicle fuel inlet.

According to an aspect of some embodiments of the present invention there is provided a method for monitoring a fuel inlet comprising analyzing images provided in the vicinity of a fuel dispensing pump and determining whether a fuel delivery nozzle is inserted inside a vehicle fuel tank inlet.

According to some embodiments of the invention, the images are provided by at least one imaging device.

According to some embodiments of the invention, the images are analyzed by at least one image processing application.

According to some embodiments of the invention, the at least one imaging device comprises a handheld camera.

According to some embodiments of the invention, the at least one imaging device provides images of the fuel delivery nozzle.

According to some embodiments of the invention, the at least one imaging device provides images of the vehicle.

According to some embodiments of the invention, the at least one imaging device comprises a plurality of cameras each providing at least one image.

According to some embodiments of the invention, the at least one imaging device continuously provides images so as to detect whether the fuel delivery nozzle is inserted inside the vehicle fuel inlet.

According to some embodiments of the invention, the images are continuously analyzed so as to detect whether the fuel delivery nozzle is inserted inside the vehicle fuel inlet.

According to some embodiments of the invention, a plurality of signals are continuously generated before and during fuel dispensing when it is detected that the fuel delivery nozzle is not inserted inside the vehicle fuel inlet.

According to some embodiments of the invention, a plurality of signals are continuously generated before and during fuel dispensing when it is detected that the fuel delivery nozzle is inserted inside the vehicle fuel inlet.

According to some embodiments of the invention, an authorization to dispense fuel is generated when it is determined that the fuel delivery nozzle is inserted inside the vehicle fuel tank inlet and that a payment method has been accepted.

According to some embodiments of the invention, the at least one imaging device automatically provides images when the vehicle enters the vicinity of a fuel dispenser in a vehicle fueling service station.

According to some embodiments of the invention, fuel dispensing is automatically authorized when it is determined that the fuel delivery nozzle is inserted inside the vehicle fuel inlet and that a payment method has been accepted, without the need for any additional action.

According to some embodiments of the invention, the fuel inlet monitoring system further comprises a database containing information about at least one of vehicle models, general service station layouts, specific authorized vehicles, specific operators of vehicles and specific service stations in order to determine whether the fuel delivery nozzle is inserted in the vehicle fuel inlet.

According to some embodiments of the invention, the at least one image processing application interfaces with the database to determine the expected location of the fuel tank inlet.

According to some embodiments of the invention, the at least one image processing application analyzes previously obtained images provided by the at least one imaging device to determine the expected location of the fuel tank inlet.

According to some embodiments of the invention, the vehicle is identified by a decal attached to the vehicle.

According to some embodiments of the invention, additional information is accessed to determine whether to authorize the fuel purchase when it is not clear whether the fuel delivery nozzle is inserted inside the vehicle fuel inlet.

According to some embodiments of the invention, the additional information comprises a profile containing information on at least one of the vehicle and the vehicle operator.

According to some embodiments of the invention, the profile includes previously obtained images.

According to some embodiments of the invention, an alert signal is generated when the fuel inlet monitoring system detects that a fuel delivery nozzle that was previously detected as being inserted inside the vehicle fuel inlet is no longer inserted inside the vehicle fuel inlet.

According to some embodiments of the invention, fuel dispensing is automatically stopped by the generation of an alert signal indicating that a fuel delivery nozzle that was previously detected as being inserted inside the vehicle fuel inlet is no longer inserted inside the vehicle fuel inlet.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures generally, like components are indicated with like numerals, however, it should be noted that in some figures similar elements to those indicated in previous figures are provided with a new leading figure number. For example, the component labeled 316 in FIG. 9 is generally the same type of component as the component labeled 116 in FIG. 1.

In the drawings:

FIG. 1 is a schematic illustration of a fuel inlet monitoring system according to some embodiments of the invention;

FIG. 2 contains schematic illustrations of potential locations of a fuel nozzle utilized in connection with a fuel inlet monitoring system according to some embodiments of the invention;

FIG. 3 is a schematic illustration of a fuel inlet monitoring system utilizing a zoom feature according to some embodiments of the invention;

FIG. 4 is a schematic diagram illustrating different system states in a fueling procedure according to some embodiments of the invention;

FIG. 5 is a schematic illustration of a fuel inlet monitoring system according to some embodiments of the invention;

FIG. 6 is a schematic diagram illustrating methods of fueling according to some embodiments of the invention;

FIG. 7 is a flow chart illustrating the steps leading to authorization, rejection or termination of a fuel purchase according to some embodiments of the invention;

FIG. 8 is a schematic illustration of a fuel inlet monitoring system according to some embodiments of the invention;

FIG. 9 is a schematic illustration of a fuel inlet monitoring system according to some embodiments of the invention;

FIG. 10 is a schematic illustration of a fuel inlet monitoring system according to some embodiments of the invention;

FIG. 11 is a schematic diagram illustrating different parts of the system architecture of a fuel inlet monitoring system according to some embodiments of the invention;

FIG. 12 is an image illustrating potential locations for the placement of cameras and their coverage according to some embodiments of the invention;

FIG. 13 is an image illustrating potential locations for the placement of cameras and their coverage according to some embodiments of the invention; and

FIG. 14 is a system diagram of some embodiments of the fuel inlet monitoring system.

FIG. 15 is a schematic block diagram of an embodiment of a system for image processing and verification for a purchase authorization associated with fuel dispensing;

FIG. 16 is a high level flowchart diagram of a method of image processing and verification for a purchase authorization associated with fuel dispensing.

### DETAILED DISCLOSURE OF EMBODIMENTS

The present invention, in some embodiments thereof, relates to image recognition and processing associated with purchase authorization and, more particularly, but not exclusively, to image recognition and processing to ensure an authorized fuel nozzle is inserted in the fuel inlet of an authorized vehicle before and/or during fuel dispensing.

### Overview

An aspect of some embodiments of the invention relates to analyzing information obtained by a remote recognizer device with a processing application to determine whether a fuel nozzle is inserted inside a vehicle's fuel inlet.

According to some embodiments of the invention, a fuel inlet monitoring system collects data regarding a fuel delivery nozzle and a vehicle fuel tank inlet and the processing application analyzes information created by the recognizer device to generate at least one signal upon detecting that the fuel delivery nozzle is not inserted inside the vehicle fuel tank inlet of the vehicle or, alternatively, that the fuel delivery nozzle is inserted inside the fuel tank inlet.

According to some embodiments of the invention, the remote recognizer device comprises at least one scanner. Optionally, the scanner is a laser scanner and/or laser-based distance measurement scanner. Optionally, the scanner utilizes optical remote sensing technology. For example, the optical remote sensing technology may be Light Detection and Ranging (LIDAR).

According to some embodiments of the invention, the scanner is an optical code reader. The optical code may be, for example, a bar code or qr code. Optionally, the optical code reader identifies a vehicle and/or fuel delivery nozzle by an optical code located on the vehicle and/or fuel delivery nozzle. For example, the optical code reader reads an optical code contained on a sticker affixed to the vehicle and/or fuel delivery nozzle.

According to some embodiments of the invention, the remote recognizer device comprises an ultrasonic device. For example, the ultrasonic device may be an ultrasonic level or sensing system.

According to some embodiments of the invention, the remote recognizer device comprises an imaging device and the processing application comprises an image processing application. Optionally, the imaging device is a Complementary Metal-Oxide-Semiconductor (CMOS) sensor. In some embodiments of the invention, the imaging device is a charge-coupled device (CCD).

According to some embodiments of the invention, the imaging device utilizes a telecentric lens. Optionally, the remote scanner utilizes the parallax method to analyze images from a plurality of cameras, in which the displacement or difference in the apparent position of an object viewed along two different lines of sight, and measured by the angle or semi-angle of inclination between those two lines, is used, for example, to determine distances of objects and of parts of objects. For example, cameras comprising the plurality of cameras may be oriented to provide varying angles analyzed with the parallax method.

According to some embodiments of the invention, two dimensional pictures are obtained. Optionally, distance is reconstructed using a plurality of images. In some embodiments of the invention, three dimensional (3D) pictures are obtained. Three dimensional pictures may be obtained, for example, using a stereoscopic camera.

According to some embodiments of the invention, the recognizer reconstructs relative (or absolute) 3D or 2.5D positions of the nozzle and the inlet, for example, using distance measurement or image processing from one or more images.

According to some embodiments of the invention, the fuel inlet monitoring system identifies the relative locations of fuel delivery nozzles and fuel tank inlets. Optionally, the locations of the nozzles and inlets, and/or their relative locations to each other, are monitored throughout the payment authorization and fueling process, by creating frequent images or video of them, to ascertain whether the nozzle is inserted inside the inlet.

In an exemplary embodiment of the invention, fuel dispensing will not be authorized until the fuel inlet monitoring system determines that the fuel nozzle is inserted inside the fuel inlet of an authorized vehicle. Optionally, fuel dispensing will not be authorized until the fuel inlet monitoring system determines the fuel nozzle is being used on the side of the vehicle on which the fuel inlet is located. Optionally, fuel dispensing will not be authorized until the fuel inlet monitoring system determines that the authorization is being made at an authorized time. For example, the authorized time may be a pre-determined time of day, day of week, date of month, etc.

According to some embodiments of the invention, the requirements of this system prevent the fraudulent procurement of fuel for an unauthorized activity or to a container or vehicle other than the vehicle which the person or entity paying for refueling intends to pay to refuel and/or will claim to pay to refuel.

In an exemplary embodiment of the invention, once the system ascertains that the nozzle is inserted inside the fuel inlet, and it is later ascertained that the fuel nozzle is no longer inserted in the fuel inlet and that an attempt is being made to continue dispensing fuel, an alert signal is sent out. Optionally, this alert signal leads to an automatic shut off of the fuel delivery. According to some embodiments of the invention, this shut off feature prevents the fraudulent procurement of fuel to a container or vehicle other than the authorized vehicle even where the fueling begins in a non-fraudulent manner.

In an exemplary embodiment of the invention, the shut off feature is activated even when the fuel nozzle remains in the fuel inlet, if the amount of fuel dispensed exceeds a certain pre-determined amount. For example, the pre-determined amount may be the amount of fuel the authorized vehicle's fuel tank is capable of holding. Optionally, the pre-determined amount is a time based limit. For example, the pre-determined amount may be a certain amount of fuel per day or per week.

According to some embodiments of the invention, the shut off feature prevents the fraudulent procurement of fuel for vehicles, containers or uses that are not authorized. According to some embodiments of the invention, this shut off feature automatically prevents safety hazards from occurring. Optionally, the alert signal is sent to a third party person or computer that has the ability to activate the shut off feature. In some embodiments of the invention, the alert signal is sent to a third party person or computer that does not have the ability to activate the shut off feature, but acts as a notification.

In an exemplary embodiment of the invention, the fuel inlet monitoring system utilizes at least one camera to obtain images of the nozzle, the fuel inlet and/or other objects. Optionally, the at least one camera is mounted in the proximity of the fuel dispenser pump. Optionally, the at least one camera is an existing service station camera. In some embodiments of the invention, the at least one camera is a specially installed camera.

According to some embodiments of the invention, the at least one camera is not mounted. Optionally, the at least one camera is a portable camera such as a cell phone camera.

In an exemplary embodiment of the invention, the images obtained by the cell phone camera are sent to the fuel inlet monitoring system's computer via an application downloaded specifically for use with this fuel inlet monitoring system. In some embodiments of the invention, the images are manually transmitted to a phone number, email or other destination using the cell phone. Alternatively, a portable camera other than a cell phone is used to create the images which are then transmitted by a separate device.

According to some embodiments of the invention, the fuel inlet monitoring system utilizes a plurality of cameras. Optionally, each camera of the plurality of cameras works independently of the other cameras. Alternatively, at least one camera of the plurality of cameras communicates with at least one other camera of the plurality of cameras.

In an exemplary embodiment of the invention, the fuel inlet monitoring system utilizes both mounted and unmounted cameras. Optionally, the fuel inlet monitoring system utilizes both portable and non-portable cameras. In an exemplary embodiment of the invention, the fuel inlet monitoring system utilizes both existing and specially installed cameras.

According to some embodiments of the invention, the fuel inlet monitoring system identifies a vehicle. Optionally, the fuel inlet monitoring system identifies the make and/or model of the vehicle. In an exemplary embodiment of the invention, the fuel inlet monitoring system identifies the specific vehicle.

According to some embodiments of the invention, the fuel inlet monitoring system uses at least one of the following methods to identify the vehicle: picture and/or video analysis of the vehicle plate number picture and/or video analysis of an optical identifier coupled to the vehicle, picture and/or video analysis of the shape of the vehicle; picture and/or video analysis of unique features of the vehicle; recognition of a radio-frequency identification (RFID) tag; and manual input of the vehicle license plate number or Vehicle Identification Number (VIN).

In an exemplary embodiment of the invention, the fuel inlet monitoring system identifies a fuel nozzle. Optionally, the fuel nozzle is identified using picture and/or video analysis and/or shape recognition software to identify an optical identifier coupled to the nozzle or unique features of the nozzle, or an RFID tag. In an exemplary embodiment of the invention, the fuel inlet monitoring system comprises painting fuel nozzles certain colors in order to stand out from other objects and facilitate their identification.

In an exemplary embodiment of the invention, the image recognition software and/or the at least one camera are guided by existing data in determining the location of the fuel inlet and/or fuel nozzle. Optionally, the fuel inlet monitoring system uses information from a data base, together with physical features of the nozzles, vehicles and fuel inlets captured in the images obtained by on-site cameras, to identify the relative locations of nozzles and to identify the expected relative location of a fuel inlet, e.g., rear third of the driver's side, wherein the opening to the fuel tank is expected to be found.

In an exemplary embodiment of the invention, the images are analyzed by a computer and/or application internal to the at least one camera. In some embodiments of the invention, the images are sent to an external computer for analysis.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. It should be noted that the embodiments are not meant to be mutually exclusive with respect to their features; rather they illustrate various features of the invention which may be mixed and matched, using a small number of exemplary embodiments.

### Vehicle Identification

According to some embodiments of the invention, the fuel inlet monitoring system is activated by at least one of removing the nozzle from the fuel dispenser pump, pressing the lever of the fuel delivery nozzle, pressing a fueling request button on the fuel dispenser pump, pressing any button on the fuel dispenser pump which creates a fuel dispensing request, an employee of the fueling service station initiating a fuel dispensing request and an automated card reader operating at the fuel service station after a card has been swiped. Optionally, the imaging device is configured to obtain images of at least one of the following features of a vehicle upon activation of the fuel inlet monitoring system: the license plate number of the vehicle, the VIN of the vehicle, the location of a decal placed on the vehicle, the unique identifier of a decal placed on the vehicle, the shape of the vehicle, the physical dimensions of the vehicle, the color of the vehicle, a specially prepared label on or next to a fuel inlet, the mini-door outside a fuel inlet, the shape of the mini-door covering the fuel inlet, the shape of the fuel inlet, any physical feature unique to the vehicle. In some embodiments of the invention, the fuel inlet monitoring system is activated, and the at least one imaging device is configured to automatically obtain images, when a vehicle enters the vicinity of at least one fuel dispensing pump in a vehicle fueling service station.

According to some embodiments of the invention, the at least one imaging device is mounted in the vicinity of at least one fuel dispenser in the vehicle fueling service station. In some embodiments of the invention, the at least one imaging device is not mounted. Optionally, the at least one imaging device is a plurality of cameras comprising at least one camera mounted in the vicinity of at least one fuel dispenser in the vehicle fueling service station and at least one camera that is not mounted.

### Detecting Nozzle Location

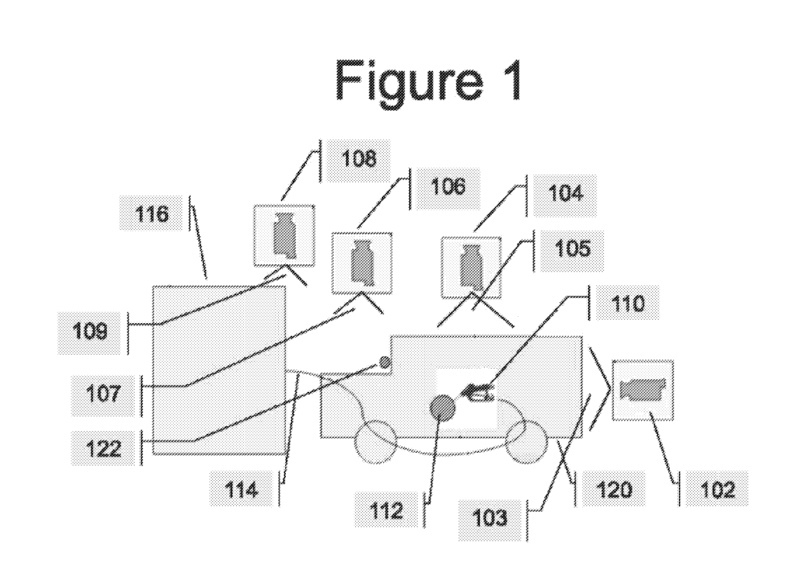

Referring now to the drawings, FIG. 1 illustrates a four camera system for detecting whether a nozzle is inserted into the fuel inlet of an authorized vehicle, according to some embodiments of the invention. Optionally, camera 102 is positioned in a fuel service station at a height and angle to facilitate imaging of a license plate located on the back of vehicle 120 refueling at fuel dispenser pump 116. For example, camera 102 may be placed at a height of between 0 and 4 meters above the ground and oriented toward the probable location of license plate location on the rear of the vehicle when the driver's side of the vehicle is closest to the fuel dispensing pump.

In an exemplary embodiment of the invention, two cameras 102 are used, with one on each side of the fuel dispensing pump so that one is oriented toward the probable location of the license plate location on the rear of the vehicle when the driver's side of the vehicle is closest to the fuel dispensing pump and one is oriented toward the probable location of the license plate location on the rear of the vehicle when the passenger side of the vehicle is closest to the fuel dispensing pump.

According to some embodiments of the invention, camera 104 is positioned above the fuel dispensing area at a height and angle to facilitate imaging of fuel inlet 112 on vehicle 120 as well as fuel nozzle 110 attached to fuel cable 114 emanating from fuel dispenser pump 116. In addition to creating images of fuel nozzle 110 and fuel inlet 112, the camera is positioned to create an image showing whether fuel nozzle 110 is inserted inside fuel inlet 112. For example, camera 104 may be placed at a height of between 0 and 6 meters above the ground and oriented toward the probable location of the fuel inlet of the vehicle at an angle of between 20 and 160 degrees to the perpendicular. In an exemplary embodiment, the height is 1 meter and the angle is 90 degrees.

According to some embodiments of the invention, camera 106 is positioned above the area where the vehicle windshield will be located during fuel dispensing at a height and angle to facilitate imaging of an optical identifier 122 coupled to the vehicle windshield or to another part of vehicle 120. For example, camera 106 may be placed at a height of between 1 and 10 meters above the ground and oriented towards the probable location of the vehicle windshield when the driver's side of the vehicle is closest to the fuel dispensing pump at an angle of between 20 and 160 degrees to the perpendicular. In an exemplary embodiment, the height is 1.5 meters and the angle is 90 degrees.

In an exemplary embodiment of the invention, two cameras 106 are used, with one on each side of the fuel dispensing pump so that one is oriented toward the probable location of the vehicle windshield when the driver's side of the vehicle is closest to the fuel dispensing pump and one is oriented toward the probable location of the vehicle windshield when the passenger side of the vehicle is closest to the fuel dispensing pump.

In some embodiments of the invention, camera 106 is positioned to the side of the area where the vehicle windshield will be located during fuel dispensing at a height and angle to facilitate imaging of an optical identifier coupled to the vehicle windshield or to another part of vehicle 120. For example, camera 106 may be placed at a height of between 0 and 3 meters above the ground and oriented toward the probable location of the vehicle windshield, at an angle of between 20 and 160 degrees to the perpendicular. In an exemplary embodiment, the height is 1.5 meters and the angle is 90 degrees.

In an exemplary embodiment of the invention, two side cameras 106 are used, with one on each side of the fuel dispensing pump so that one is oriented toward the probable location of the vehicle windshield when the driver's side of the vehicle is closest to the fuel dispensing pump and one is oriented toward the probable location of the vehicle windshield when the passenger side of the vehicle is closest to the fuel dispensing pump.

According to some embodiments of the invention, camera 108 is positioned above the fuel dispensing area at a height and angle to facilitate imaging of fuel cable 114 and fuel dispenser pump 116 in order to create images of fuel nozzle 110 at all points between the cradle on fuel dispenser pump 116 and fuel inlet 112, which cameras 104 and 106 are not able to obtain, according to some embodiments of the invention. For example, camera 108 may be placed at a height of between 1.5 and 10 meters above the ground and oriented toward the area from the fuel dispenser pump to the vehicle, at an angle of between 20 and 160 degrees to the perpendicular. In an exemplary embodiment, the height is 3 meters and the angle is 35 degrees.

According to some embodiments of the invention, each of the images obtained by cameras 102, 104, 106 and 108 are analyzed, using optical recognition software, to ascertain the identity of the objects and license plate number contained within the images. Optionally, cameras 102, 104, 106 and 108 are able to transmit images to each other and/or to a computer in a separate location. The range of camera 102 is illustrated by the area 103 between the lines emanating from cameral 102, according to some embodiments of the invention. Likewise, range 105 demonstrates the range of camera 104, range 7 demonstrates the range of camera 106 range and 109 demonstrates the range of camera 108, according to some embodiments of the invention. Alternatively, there are less than four cameras.

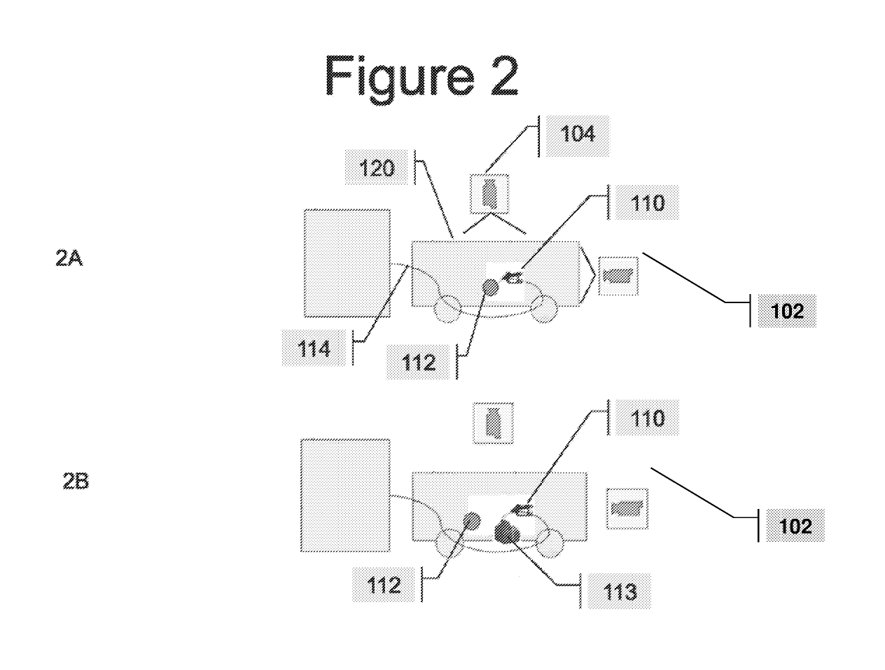

FIG. 2 illustrates the imaging of fuel nozzle 110 both when inserted inside fuel inlet 112 (FIG. 2A) and when not inserted inside fuel inlet 112 (FIG. 2B), according to some embodiments of the invention.

According to some embodiments of the invention, the fuel inlet monitoring system contains circuitry to detect when the fuel delivery nozzle is inserted inside a fuel tank inlet, for example a RFID tag on the vehicle and a RFID tag reader on the fuel delivery nozzle. Optionally, the system generates a signal upon detecting that the fuel delivery nozzle is inserted inside a fuel tank inlet of a vehicle which is different from the signal generated upon detecting that the fuel delivery nozzle is not inserted inside a fuel tank inlet of a vehicle. In some embodiments of the invention, the system only generates a signal upon detecting that the fuel delivery nozzle is inserted inside a fuel tank inlet of a vehicle.

In an exemplary embodiment of the invention, images are obtained from a plurality of cameras oriented to provide varying angles and these images are analyzed to prevent a false signal from being generated. For example, a camera located to the side of the vehicle may provide an image in which the fuel delivery nozzle is located in front of the vehicle inlet and in which the front of the fuel delivery nozzle does not appear. The image processing application may then indicate that the fuel delivery nozzle is inserted inside the vehicle fuel tank inlet. A second camera, located above the vehicle, may, however, provide an image showing that the entire fuel delivery nozzle is visible and is simply blocked from the side view due to its ninety degree angle. In this case, the image from the second camera will prevent the generation of a false signal which would have indicated that the fuel delivery nozzle is inserted inside the vehicle fuel tank inlet.

In another example, an overhead camera may indicate that the fuel delivery nozzle is inserted inside the vehicle fuel tank inlet while a side camera located behind the rear of the vehicle may indicate that the fuel delivery nozzle is inserted inside a portable fuel container.

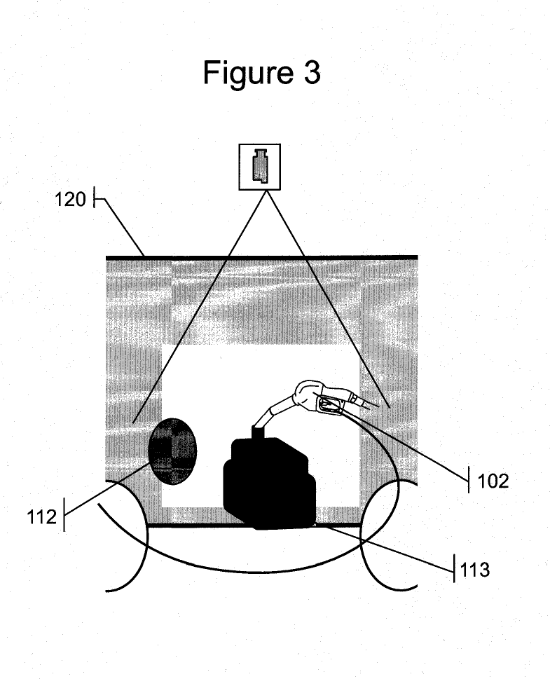

As seen in FIG. 2B, the determination that the nozzle is not inserted inside the fuel inlet may prevent the unauthorized dispensation of fuel. For example, the determination that the nozzle is not inserted inside the fuel inlet may prevent the unauthorized dispensation of fuel into a portable fuel container 113. Optionally, camera 102 has a zoom feature allowing more close up views. FIG. 3 illustrates a close up image of the location of fuel nozzle 110. For example, the zoom feature may provide a close up picture of fuel nozzle 110 inserted inside portable fuel container 113 and not inserted inside fuel inlet 112 of vehicle 120, as depicted in FIG. 3.

In an exemplary embodiment of the invention, the system uses information about inlet or nozzle location to choose which part of the image to process and/or to which part of the image to perform a physical zoom and/or pan.

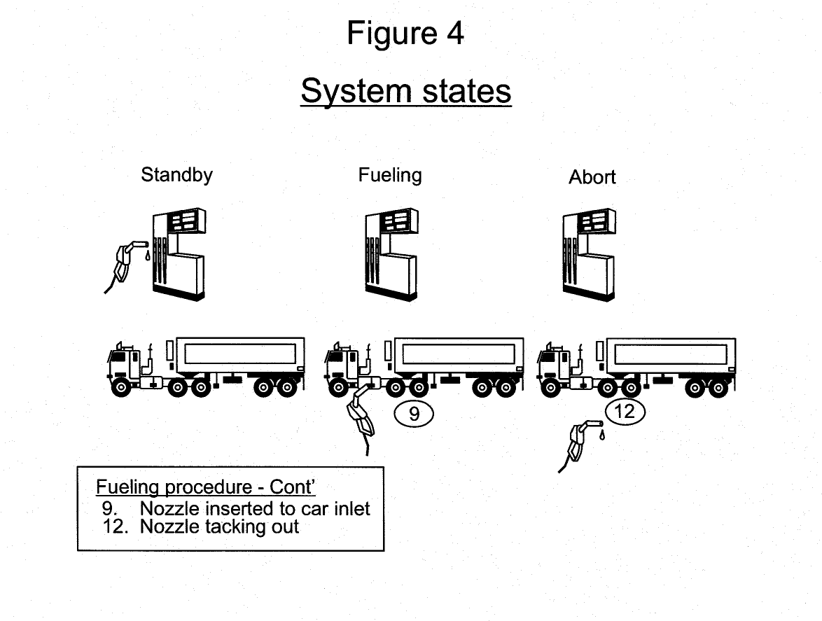

FIG. 4 illustrates the three system states “Standby,” “Fueling” and “Abort” in a fueling procedure according to some embodiments of the invention. Standby refers to the stage in the refueling process before fuel nozzle 110 is inserted inside fuel inlet 112. Fueling refers to the stage in the refueling process when fuel nozzle 110 is inserted inside in fuel inlet 112. Abort refers to the stage in the refueling process after fuel nozzle 110 is inserted in, and then removed from, fuel inlet 112.

### First Embodiment

### System Hardware

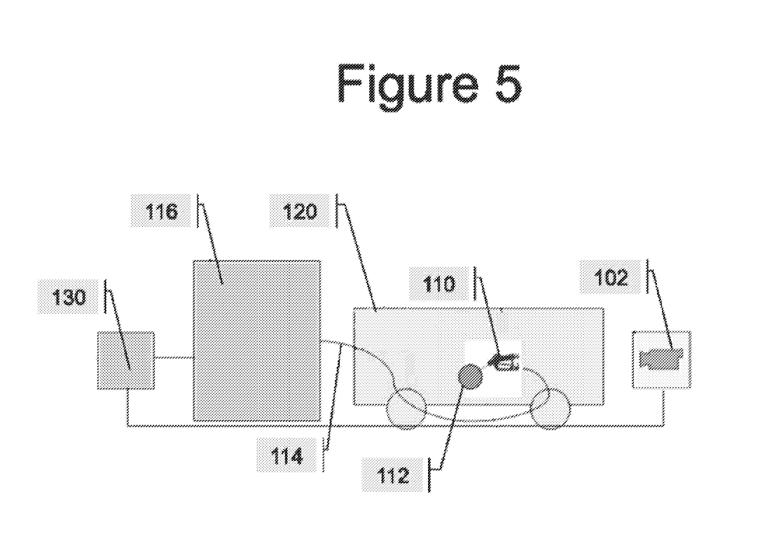

FIG. 5 illustrates a fuel inlet monitoring system containing one mounted optical device, according to some embodiments of the invention. According to some embodiments of the invention, the fuel inlet monitoring system is interfaced with a service station, including at least one fuel dispensing pump 116, containing at least one fuel nozzle 110 connected to fuel dispensing pump 116 by fuel cable 114, and at least one optical device in the vicinity of at least one fuel dispensing pump 116 at the service station at a position that provides a view of the vehicle and its plate number or any other unique identifier and at least one image processing application. Optionally, the at least one optical device is a camera 102. Optionally, camera 102 creates an image and/or video of a vehicle 120, the vehicle's fuel inlet 112 and the fuel nozzle 110. In an exemplary embodiment of the invention, the fuel inlet monitoring system comprises one or more of existing cameras at a service station.

According to some embodiments of the invention, the fuel inlet monitoring system further comprises at least one computer. Optionally, the at least one computer is configured to run said image processing application. Optionally, the at least one computer is a plurality of computers configured wherein at least one computer of the plurality of computers is configured to communicate with at least one additional computer. In an exemplary embodiment of the invention, a plurality of computers is configured to run said image processing application.

According to some embodiments of the invention, the at least one computer is internal to camera 102. The built-in computer processes the images obtained by camera 102 to identify the nozzle, the vehicle, the fuel inlet and their respective locations. Optionally, camera 102 is equipped with an internal transceiver. In an exemplary embodiment of the invention, the internal transceiver transmits the results of the computer processing of the images to the fuel dispensing pump 116.

According to some embodiments of the invention, camera 102 lacks a built-in computer. Optionally, camera 102 sends the obtained images to at least one independent computer 130. For example, a built-in transceiver in camera 102 may transmit the obtained images to independent computer 130. Optionally, independent computer 130 is located on site in the fuel service station. For example, independent computer 130 may be part of the service station's computing network.

In some embodiments of the invention, the independent computer is located in a remote location. The term “remote location” means a location other than the service station. Optionally, the remote location is an office of a company operating the fuel inlet monitoring system. Optionally, the independent computer located in a remote location is interfaced with a plurality of fuel inlet monitoring systems operating at least one fuel service station. In an exemplary embodiment of the invention, the use of a remote computer provides a service station with the flexibility of using the fuel inlet monitoring system without the need to obtain or install a computer or image processing application.

According to some embodiments of the invention, camera 102 lacks a built-in transceiver and is interfaced to independent computer 130 directly or via proxy. Optionally, the independent computer operates in a cloud environment or any other location capable of storing a database and relevant applications. In an exemplary embodiment of the invention, the independent computer serves numerous service stations.

According to some embodiments of the invention, the identification indicia obtained from the picture and video analyses are forwarded to the independent computer 130, located either locally or in a remote location.

### Database

According to some embodiments of the invention, the fuel inlet monitoring system comprises at least one computer which contains at least one database. Optionally, the fuel inlet monitoring system comprises a plurality of computers in which at least two computers each contain at least one database. In an exemplary embodiment of the invention, the fuel inlet monitoring system accesses information on the at least one database to guide imaging, image processing, and/or fuel authorization.

According to some embodiments of the invention, the imaging device is configured to obtain images in the area of the expected location of the fuel delivery nozzle, vehicle and/or vehicle fuel inlet based on at least one of the following: images already obtained by said imaging device, images obtained by a different imaging device, information in the at least one database.

According to some embodiments of the invention, the at least one database contains vehicular identification information. Optionally, the at least one database contains a general list of vehicle models including at least one of the following types of information: the shape of the vehicle and its components, the physical dimensions of the vehicle and its components, the location of the vehicle's fuel inlet, the type of fuel the vehicle uses, the maximum size of the vehicle's fuel tank.

According to some embodiments of the invention, the at least one database contains a specific list of vehicles authorized to receive fuel after being optically identified by the fuel inlet monitoring system, including at least one of the following types of information: the license plate number of the vehicle, the Vehicle Identification Number (VIN) of the vehicle, the location of a decal placed on the vehicle, the unique identifier of a decal placed on the vehicle, the location of a Radio-Frequency Identification (RFID) tag placed on the vehicle, the unique identifier of an RFID tag placed on the vehicle, the model of the vehicle, the shape of the vehicle and its components, the physical dimensions of the vehicle and its components, the color of the vehicle, any physical feature unique to the vehicle, the location of the vehicle's fuel inlet, the type of fuel the vehicle uses, the maximum size of the vehicle's fuel tank, the maximum amount of fuel authorized to be delivered within a pre-determined period of time, the maximum number of times fuel may be authorized within a pre-determined period of time, the times of the day in which fueling is authorized, the days of the week in which fueling is authorized, holidays on which fueling is not authorized, a credit card associated with the vehicle, debit card associated with the vehicle, a fuel card associated with the vehicle.

According to an exemplary embodiment of the invention, the maximum amount of fuel authorized to be delivered within a pre-determined period of time is used to prevent fraudulent refueling even without the use of an imaging device by preventing a subsequent refueling when less time passes than the time it takes for a vehicle to use the fuel it received in a previous fueling. For example, the pre-determined period of time may include at least one of the following time periods: one hour, six hours, one day, one week, one month and one year.

In an exemplary embodiment of the invention, fraudulent refueling is prevented even without the use of an imaging device by setting the maximum amount and pre-determined period of time to an amount that is not normally exceeded in the predetermined period of time. Optionally, fraudulent refueling is prevented even without the use of an imaging device by not allowing fuel dispensing outside of working hours.

According to some embodiments of the invention, the fuel inlet monitoring system is configured to allow an authorized representative of the entity paying for the fueling to override a rejection. Optionally, the fuel inlet monitoring system is configured to send an automated request to the authorized representative stating the reason for declining authorization and instructing the authorized representative on how they can override the rejection and authorize the fueling request.

According to some embodiments of the invention, the at least one database contains a general list of vehicle fueling service station identification information, including at least one of the following types of information: list of fuel dispenser models, physical dimensions of different components of fuel dispenser, shape of different components of fuel dispenser, color of different components of fuel dispenser, physical dimensions of different components of fuel nozzle, shape of different components of fuel nozzle, color of different components of fuel nozzle, type of fuel associated with different nozzles, physical dimensions of different components of fuel cable, shape of different components of fuel cable, color of different components of fuel cable, physical dimensions of different components of vehicle fueling service station, shape of different components of vehicle fueling service station, color of different components of vehicle fueling service station, relative distances between components of vehicle fueling service station.

According to some embodiments of the invention, the at least one database contains a specific list of vehicle fueling service station identification information, including at least one of the following types of information: list of authorized vehicle fueling service station, dispenser models located at each authorized vehicle fueling service station, physical dimensions of different components of fuel dispensers located at each authorized vehicle fueling service station, shape of different components of fuel dispensers located at each authorized vehicle fueling service station, color of different components of fuel dispensers located at each authorized vehicle fueling service station, physical dimensions of different components of fuel nozzles located at each authorized vehicle fueling service station, shape of different components of fuel nozzles located at each authorized vehicle fueling service station, color of different components of fuel nozzles located at each authorized vehicle fueling service station, type of fuel associated with different nozzles located at each authorized station, physical dimensions of different components of fuel cables located at each authorized vehicle fueling service station, shape of different components of fuel cables located at each authorized vehicle fueling service station, color of different components of fuel cables located at each authorized station, physical dimensions of different components of each authorized vehicle fueling service station, shape of different components of each vehicle fueling service station, color of different components of each vehicle fueling service station, relative distances between components at each vehicle fueling service station.

### Fuel Inlet Location

According to some embodiments of the invention, the fuel inlet monitoring system determines a probable location for the fuel inlet of the vehicle. Optionally, the fuel inlet monitoring system determines the probable location for the fuel inlet of the vehicle based on at least one of information contained in the database and previously obtained images. For example, the fuel inlet monitoring system may identify the license plate number of the vehicle from a first image provided by the at least one camera, access the database to determine the model of the vehicle which is associated with that license plate number, further access the database to determine the shape of that vehicle model and the expected location of its fuel inlet and then coordinate that information with the geometry of the vehicle as observed in a second image provided by the at least one camera, calibrate the information on the expected location of the fuel inlet to match the geometry of the vehicle and make a final determination of the expected location of the fuel inlet. In an exemplary embodiment of the invention, the fuel inlet monitoring system then analyzes at least one image from at least one camera with a range covering the fuel inlet to determine whether the fuel nozzle is inserted inside the fuel inlet.

In some embodiments of the invention, the geometry of the vehicle is not determined. For example, the fuel inlet monitoring system may not determine which side of the vehicle is the front of the vehicle and may then search for the fuel tank inlet in two different locations, one location assuming that the front of the vehicle is to the left when facing the vehicle from the fuel dispensing pump, and one location assuming that the front of the vehicle is to the right when facing the vehicle from the fuel dispensing pump.

### Profiles

According to some embodiments of the invention, the fuel inlet monitoring system creates profiles containing information about individual vehicles and/or operators of the vehicles. Optionally, the profiles comprise previous images of at least one of the vehicles during fueling processes and the operators during fueling processes. In an exemplary embodiment of the invention, the profiles comprise information about at least one of the vehicle's fuel inlet location, the vehicle's color and the vehicle's shape, the operator's identifying information.

According to some embodiments of the invention, the fuel inlet monitoring system automatically creates and updates vehicle and operator profiles. Optionally, the profiles are stored on the at least one database.

### Refueling Request

Camera 102 identifies when a nozzle has been lifted from the cradle of fuel dispenser 116, establishing a refueling request event. The term “refueling request event” means an event that indicates that an attempt is being made to dispense fuel. A refueling request event may be generated by at least one of the fueling service station's existing automated system interfaced with fuel dispenser 116, an automated card reader operating at the fuel service station after a card has been swiped, removing the nozzle from the fuel dispenser pump, pressing the lever of the fuel delivery nozzle, pressing a fueling request button on the fuel dispenser pump, pressing any button on the fuel dispenser pump which creates a fuel dispensing request and an employee of the fueling service station initiating a fuel dispensing request. The refueling request may include nozzle specifics such as, nozzle number, pump number, fuel type, and other information.

### Image Recognition

After a refueling request event, image recognition is performed by camera 102 alone, or with other cameras to identify vehicle 120, which has entered a fuel service station and has stopped near the fuel dispenser 116 or an associated pump. Optionally, camera 102 performs image processing autonomously when a vehicle enters a particular fuel dispensing area of the service station. In an exemplary embodiment of the invention, camera 102 performs image processing autonomously when a vehicle enters any part of the service station.

According to some embodiments of the invention, the at least one imaging device itself automatically performs image processing with its internal computer after obtaining images. Optionally, the at least one imaging device automatically transmits obtained images to a computer external to the imaging device for image processing. In an exemplary embodiment of the invention, the imaging device transmits obtained images to an external computer for image processing upon receiving an instruction from the customer or service station attendant.

Camera 102 establishes a unique ID for vehicle 120 and also identifies its fuel inlet 112 and the fuel nozzle 110 and their relative locations and whether fuel nozzle 110 is inserted inside fuel inlet 112. Optionally, camera 102 creates an image of the plate number of vehicle 120, or another unique identifier, or both, and interprets it, or sends it to computer 130 or an onsite computer running local software and/or to a remote server for interpretation.

According to some embodiments of the invention, the fuel inlet monitoring system incorporates vehicle identification information obtained from an independent payment system such as an RFID tag (as used herein, the term/phrase RFID tag means an electronic identification device comprising a chip and antenna utilizing radio-frequency identification), a credit card, debit card or fuel card processor, an automated or manual cash payment system, or other payment system.

According to some embodiments of the invention, camera 102 creates successive images of fuel nozzle 110 and/or fuel cable 114, before and/or during fuel dispensing, from the time fuel nozzle 110 is located in the cradle of fuel dispenser 116 until the nozzle is inserted into the fuel inlet of the authorized vehicle, and/or any time that the fuel nozzle 110 is at a position between the cradle of fuel dispenser 116 and the fuel inlet.

According to some embodiments of the invention, at least one camera provides successive images of the vehicle, before and/or during fuel dispensing. Optionally, the fuel inlet monitoring system determines, before and/or during fuel dispensing, whether the vehicle remains in the same location following the determination that the fuel nozzle is inserted inside the fuel inlet.

According to some embodiments of the invention, at least 10 images of the fuel nozzle, fuel cable, fuel inlet and/or the vehicle are created and/or analyzed, per minute. Optionally, at least 60 images are created, and/or analyzed, per minute. Optionally, less than 10 images are created, and/or analyzed, per minute.

According to some embodiments of the invention, the at least one image processing application analyzes images successively before and/or during fuel dispensing to determine whether said fuel delivery nozzle is inserted inside a fuel tank inlet of a vehicle. Optionally, the fuel inlet monitoring system analyzes images each time images are provided by said at least one imaging device to determine whether said fuel delivery nozzle is inserted inside a fuel tank inlet of a vehicle. In some embodiments of the invention, the fuel inlet monitoring system analyzes images less frequently than images are provided by said at least one imaging device.

According to some embodiments of the invention, the fuel inlet monitoring system generates successive signals before and/or during fuel dispensing indicating whether said fuel delivery nozzle is inserted inside a fuel tank inlet of a vehicle.

Optionally, the fuel inlet monitoring system generates successive signals each time the at least one image processing application analyzes images created by said at least one imaging device. In some embodiments of the invention, the fuel inlet monitoring system generates successive signals less frequently than the at least one image processing application analyzes images created by said at least one imaging device.

According to some embodiments of the invention, information is obtained by a remote recognizer device comprising at least one scanner. Optionally, the scanner is a laser scanner and/or laser-based distance measurement scanner. Optionally, the scanner utilizes optical remote sensing technology. For example, the optical remote sensing technology may be Light Detection and Ranging (LIDAR).

According to some embodiments of the invention, the scanner is an optical code reader. The optical code is, for example, a bar code or qr code. Optionally, the optical code reader identifies a vehicle and/or fuel delivery nozzle by an optical code located on the vehicle and/or fuel delivery nozzle. In an exemplary embodiment of the invention, the optical code is contained on a sticker located on the vehicle and/or fuel delivery nozzle.

According to some embodiments of the invention, the remote recognizer device comprises an ultrasonic device. Optionally the ultrasonic device is an ultrasonic level or sensing system.

According to some embodiments of the invention, the remote recognizer device comprises at least one imaging device. Optionally, the imaging device is a Complementary Metal-Oxide-Semiconductor (CMOS) sensor. Optionally, the imaging device is a charge-coupled device (CCD). Optionally, the imaging device utilizes a telecentric lens.

In an exemplary embodiment of the invention, the remote scanner utilizes the parallax method to analyze images from a plurality of cameras, in which the displacement or difference in the apparent position of an object viewed along two different lines of sight, and measured by the angle or semi-angle of inclination between those two lines, is used, for example, to determine distances of objects and of parts of objects. Optionally, the cameras comprising the plurality of cameras oriented to provide varying angles, for example two cameras may point in at different angles, two cameras may look at same location from different angles and one or more than one camera can change angle compared to other cameras and/or zoom during use.

According to some embodiments of the invention, two dimensional pictures are obtained. Optionally, distance is reconstructed using a plurality of images. In some embodiments of the invention, three dimensional (3D) pictures are obtained. Three dimensional pictures may be obtained, for example, using a stereoscopic camera.

According to some embodiments of the invention, the recognizer reconstructs relative (or absolute) 3D or 2.5D positions of the nozzle and the inlet, for example, using distance measurement or image processing from one or more images.

### RFID Tag Recognition

According to some embodiments of the invention, the fuel inlet monitoring system comprises an RFID tag identifier located in the vicinity of at least one fuel dispenser in the vehicle fueling service station. Optionally, the RFID tag identifier is configured to automatically identify vehicles by their RFID tag as they enter the vicinity of said at least one fuel dispenser in said vehicle fueling service station. In some embodiments of the invention, the RFID tag identifier is configured to manually identify vehicles by their RFID tag upon at least one of removing the nozzle from the fuel dispenser pump, pressing the lever of the fuel delivery nozzle, pressing a fueling request button on the fuel dispenser pump, pressing any button on the fuel dispenser pump which creates a fuel dispensing request, an employee of the fueling service station initiating a fuel dispensing request and an automated card reader operating at the fuel service station after a card has been swiped. These options and others described herein provide the fuel inlet monitoring system with the flexibility to work both at high tech levels involving automatic action and at low tech levels involving manually directed actions.

### Image Analysis

The internal computer in camera 102 and/or independent computer 130 processes each of the images obtained from at least one camera 102 using software specially designed to process a plurality of images and/or videos of nozzles, vehicles and fuel inlets. Optionally, the built-in computer located inside camera 102 and/or independent computer 130 comprises software to carry out picture and video analysis. Optionally, the software first identifies the vehicle via a unique vehicle identifier located on the vehicle and, if unsuccessful in locating a unique vehicle identifier, follows an order of priorities in attempting to identify the vehicle. The order of priorities, in descending order of priority may, for example, include unique vehicle identifier, license plate number, vehicle model number, vehicle shape and vehicle shape patterns.

### Matching Algorithm

A customized “K-nearest neighbor” algorithm is utilized in some embodiments of the invention to obtain fuzzy classification of the obtained images. Optionally, the algorithm guides the fuel inlet monitoring system in locating the fuel inlet and in making authorization determinations.

According to some embodiments of the invention, the algorithm is a matching algorithm based on video and/or frame recognition integrating various techniques from pattern recognition methods utilizing the following steps:
1. Preprocessing: segmenting the pattern identified as a pattern of interest from the background. Patterns of interest include patterns matching the patterns of fuel nozzles, nozzle pipes (hereinafter referred to as “cables”) vehicles and fuel inlets.
2. Feature selection: analyzing the geometry and structure of the segmented patterns.
3. Optimization: comparing selected features against unselected ones for the possibility of a better classification and/or match.
4. Convolution: matching optimized images with actual images of nozzles, cables, vehicles and fuel inlet structures associated with the vehicles matching the imaged vehicles.
5. Measurements: calculating the distance between the vehicle and the at least one camera and using that information to optimize the results from each of the above steps.
6. Fuzzy classification: utilizing the known fuzzy classification process to identify cables and their location to provide a yes or no indication as to whether a nozzle is inserted in and/or removed from a fuel inlet before and during a fueling process.
7. The fuzzy method: utilizing the known fuzzy method to overcome identification challenges such as poor lighting, sun glare, inclement weather, interfering images.

### Fueling Authorization

Using images obtained and transmitted by Camera 102, the built-in computer located inside camera 102 and/or independent computer 130 identifies the removal of fuel nozzle 110 from the cradle of fuel dispenser 116, establishing a refueling request event. A refueling request event can be received by an onsite computer running local software, or from a third party fuel control system, by implementing a communication protocol between the third party fuel control system and the remote server and/or onsite computer running local software. Optionally, a refueling request event is generated by a card that is read by the fueling service station's automated system, or another identification and/or payment means provided to the driver, such as an RFID chip.

According to some embodiments of the invention, the third party fuel control system sends the built-in computer located inside camera 102 and/or independent computer 130 an identification request, with the relevant nozzle information. The built-in computer located inside camera 102 and/or independent computer 130 matches the nozzle information with the authorization response, and verifies that the nozzle is a proper match for the fuel product required by the identified vehicle. Where the nozzle is not a proper match for the identified vehicle, the fuel inlet monitoring system will provide a fueling alert.

### Vehicle Authorization

Once the identification indicia are interpreted, by the internal computer in camera 102 and/or independent computer 130, an authorization request is sent to one or more of a remote server, an onsite computer running local software and a third party fuel control system.

According to some embodiments of the invention, the remote server, onsite computer running local software and/or third party fuel control system makes an automated decision to authorize or decline refueling and relays that decision to a fuel control system operating at the refueling facility. Optionally, the remote server, onsite computer running local software and/or third party fuel control system control the fueling process before and during fueling.

In an exemplary embodiment of the invention, the remote computer queries a database storing, accessing and modifying customer and vehicle records. Optionally, the remote computer analyzes stored data and obtained images to determine the propriety of authorizing purchases. Optionally, the fuel dispensing station will not discharge fuel prior to receiving a remote authorization. In an exemplary embodiment of the invention, the fuel dispensing station will not discharge fuel prior to verifying that the fuel inlet in which the fuel nozzle is inserted is an authorized vehicle.

### Payment Authorization

In an exemplary embodiment of the invention, the fuel inlet monitoring system incorporates payment information and approvals such that the identification of the vehicle, fuel inlet, fuel nozzle and/or other predetermined hardware suffices to authorize both the appropriateness of fuel dispensing and the payment for the fuel dispensing.

For example, the operator of the vehicle or an employee of the fueling service station places the fuel delivery nozzle inside the vehicle's fuel inlet and attempts to begin fueling by pressing on the lever of the fuel delivery nozzle. The fuel inlet monitoring system is then activated and provides images of the area of the vehicle fuel inlet and of the vehicle. Upon determining that the fuel delivery nozzle is inserted inside the vehicle fuel inlet and upon identifying the vehicle as an authorized vehicle with a pre-authorized payment plan, the fueling is authorized and the fuel pump begins dispensing fuel.

In some embodiments of the invention, the fuel inlet monitoring system is activated as soon as the fuel delivery nozzle is removed from the fuel dispensing pump, without the need to press the lever of the fuel delivery nozzle. Alternatively, the fuel inlet monitoring system is activated as soon as the vehicle arrives in the vicinity of the fuel dispensing pump. In some embodiments of the invention, more or less information is required before the fuel inlet monitoring system authorizes fuel dispensing.

In some embodiments of the invention, the existing payment system works in conjunction with the authorization of this invention, such that fuel dispensing requires both an authorization from the fuel inlet monitoring system described in this invention and from a separate payment system. For example, fuel dispensing may require both an authorization from the fuel inlet monitoring system indicating that the fuel delivery nozzle is inserted inside an authorized vehicle fuel inlet and a separate payment authorization indicating that a payment has been obtained or pre-approved. Optionally, the payment authorization is obtained from an existing payment authorization system interfaced with the fueling service station.

In an exemplary embodiment of the invention, the payment authorization is obtained from at least one of a credit card, debit card or fuel card that is physically entered, swiped, placed in proximity of said manual payment machine, or whose numbers are manually entered or whose image is provided by the at least one imaging device, a manually entered VIN, a manually entered license plate number, a manually

entered drivers license number, an RFID tag, an automated cash payment system and a manual cash payment system. Optionally, the automated cash payment system comprises a manual payment machine located in the fueling service station.

According to some embodiments of the invention, fuel dispensing requires an identification of the vehicle as an authorized vehicle in addition to the requirements for a confirmation that the fuel nozzle is inserted in the fuel inlet and a payment authorization. Alternatively, fuel dispensing only requires an identification of the vehicle as an authorized vehicle and a payment authorization. In some embodiments of the invention, fuel dispensing only requires an identification of the vehicle as an authorized vehicle.

According to some embodiments of the invention, a confirmation request, authorization or rejection is sent to a customer's mobile communication device together with relevant information and documents. Optionally, fuel dispensing requires a confirmation sent from the customer to the fuel inlet monitoring system via a mobile communication device. Optionally, fuel dispensing requires that the confirmation include an image of the vicinity of the fuel dispensing pump. For example, the image may be sent via a mobile communication device operated by an operator or passenger of the vehicle. In an exemplary embodiment of the invention, the image is sent via a mobile communication device operated by an employee of the fueling service station.

### Conditional Authorization

According to some embodiments of the invention, vehicle and payment authorizations together are sufficient to create a final fueling authorization. The authorization response, received from the remote server and/or onsite computer running local software includes a set of parameters, such as the fuel type that the vehicle is allowed to use, the maximum quantity of fuel authorized for each individual purchase, the maximum quantity of fuel authorized each week, the maximum money value of the purchase, the time and day in which purchases are authorized, the locations in which purchases are authorized, and credit cards permitted for charging. These parameters may be based on information received from the client registering a vehicle or may be based on data base records of the size of different vehicles' fuel tanks, types of fuel used by different vehicles, etc.

### Nozzle Authorization

According to some embodiments of the invention, once vehicle and payment authorizations are received, fueling authorization remains pending until a nozzle authorization is received, indicating that the fuel nozzle is inserted inside the fuel inlet of a vehicle. Optionally, after an initial detection that the fuel nozzle is inserted inside the fuel inlet of a vehicle, the fuel inlet monitoring system continues to verify that the fuel nozzle is inserted inside the fuel inlet of the vehicle.

In an exemplary embodiment of the invention, the fuel inlet monitoring system comprises circuitry to detect when a fuel nozzle which was previously determined to be inserted inside a vehicle fuel inlet may be no longer be inserted inside the fuel inlet of the vehicle. Optionally, in this case, the fuel inlet monitoring system generates a fuel dispensing alert event. For example, if the fuel inlet monitoring system initially detects that the fuel nozzle is inserted inside the fuel inlet of a vehicle and subsequently stops providing images of the vehicle's unique identifier and/or the nozzle, whether due to the nozzle and/or the vehicle's unique identifier being removed or blocked from view, or to a technical problem with the camera, a fuel alert may be generated.

According to some embodiments of the invention, the fuel dispensing alert event is activated after a predefined amount of time (for example, 3 seconds after the last image of the vehicle's unique identifier and/or the nozzle was obtained), which automatically terminates fuel dispensing and/or sends a third party notification to a person, application, cellular phone or other recipient.

### Fraud Prevention

In some embodiments, the fuel inlet monitoring system's determination of whether the fuel nozzle is inserted inside the fuel inlet of an authorized vehicle prevents the fraudulent procurement of fuel for an unauthorized dispensing to a container or vehicle other than the vehicle which the person or entity paying for refueling intends to pay to refuel and/or will claim to pay to refuel. For example, the driver of one of a fleet of delivery vehicles for a large company may use the company fuel card or RFID tag to initiate fuel dispensing after driving the authorized company vehicle into a fuel service station. After obtaining an authorization to begin fueling, the driver may place the nozzle into a fuel container or a second vehicle and attempt to fill the container. According to some embodiments of the invention, this fuel inlet monitoring system prevents the fueling from beginning since a signal is received indicating that the nozzle is not inserted inside the fuel inlet. Optionally, this fuel inlet monitoring system prevents the fueling from beginning since a signal is not received indicating that the nozzle is inserted inside the fuel inlet. In an exemplary embodiment of the invention, an authorized representative of the company may override the fuel inlet monitoring system to allow fuel dispensing in this case.

In some embodiments of the invention, this fuel inlet monitoring system does not prevent the fuel dispensing but would send an alert to an authorized representative of the company indicating that fuel dispensing is occurring while the nozzle is inserted in the fuel inlet of an authorized vehicle. Optionally, the authorized representative has the option to send a demand to terminate the fuel dispensing. In an exemplary embodiment of the invention, the authorized representative has the option to terminate future fuel dispensing involving the involved driver and/or vehicle.

In another example, the driver may insert the nozzle in the fuel inlet and begin fueling the vehicle, after which the driver may remove the nozzle from the fuel inlet and insert the nozzle inside a fuel container or a second vehicle and attempt to continue or restart fuel dispensing.

In an exemplary embodiment of the invention, this fuel inlet monitoring system prevents the fueling from continuing or restarting since a signal is received indicating that the nozzle is not currently inserted inside the fuel inlet. Optionally, this fuel inlet monitoring system would prevent the fueling from beginning since a signal is not received indicating that the nozzle is currently inserted inside the fuel inlet.

In an exemplary embodiment of the invention, an authorized representative of the company would need to override the fuel inlet monitoring system to allow fuel dispensing in this case. Alternatively, this fuel inlet monitoring system does not prevent the fuel dispensing but would send an alert to an authorized representative of the company indicating that fuel dispensing was started while the nozzle was inserted in the fuel inlet of an authorized vehicle and is continuing while the nozzle is no longer inserted inside that fuel inlet. Optionally, the authorized representative has the option to send a demand to terminate the fuel dispensing. In an exemplary embodiment of the invention, the authorized representative has the option to terminate future fuel dispensing involving the involved driver and/or vehicle.

According to some embodiments of the invention, the fuel inlet monitoring system is preprogrammed so that fueling does not start and/or is automatically terminated when the nozzle is not inserted inside the fuel inlet of an authorized vehicle with certain companies while fueling does start and/or is not automatically terminated when the nozzle is not inserted inside the fuel inlet of an authorized vehicle with other companies. Providing the companies with this option allows them to determine whether they prefer to prevent all unauthorized fuel dispensing and only be informed that an authorized fuel dispensing was attempted while the nozzle was not inserted inside the vehicle, or whether they prefer to allow a possibly unauthorized fuel dispensing to take place and to investigate the incident at a later time. Some employers may sometimes prefer to have proof of an unauthorized fuel dispensing actually being carried out and to punish the driver (for example, through a reprimand, fine, probationary period or termination).

### Safety

In some embodiments, in addition to preventing fraud, this fuel inlet monitoring system has other benefits, such as preventing hazards. For example, a fuel attendant may accidentally squeeze the nozzle before the nozzle is inserted inside the fuel inlet, leading to a spill of fuel. A nozzle may also be unintentionally dislodged from the fuel inlet, by slipping out or by being knocked out of the fuel inlet, for example, where a person, an animal, another vehicle or another object impacts the nozzle, fuel cable or vehicle. In any of these cases, it is important to terminate fueling immediately upon the removal of the nozzle from the fuel inlet to minimize the amount of spilled fuel and resultant fire and slip and fall hazards.

In some embodiments, this fuel inlet monitoring system also prevents safety hazards that are not caused by unintentional spilling. For example, in some embodiments, this fuel inlet monitoring system prevents dispensing fuel into a container. The operator of a vehicle may attempt to dispense the fuel into container not suitable for holding fuel, such as an empty coke bottle. Transporting fuel in improper containers like an empty coke bottle create a safety hazard due to the heightened risk of fire and/or explosion. Even containers that are designed to hold fuel prevent a heightened risk of fire and/or explosion and companies and/or legislatures may wish to prevent dispensing of fuel to any location other than a fuel inlet of a vehicle.

### Confirmation Request and Notification

According to some embodiments of the invention, when an authorization is not approved based on the transmitted data alone, a request for additional information (a confirmation request) is sent to the customer's pre-stored cell phone number, email and/or other communication method, through an actual phone call or via a text, email and/or other type of message. The message is sent by at least one of Camera 102, the remote server, an onsite computer running local software, a third party fuel control system, and independent computer 130.

Where a confirmation request is required, the customer will confirm the transaction using the communication device. Optionally, a notification of authorization or rejection, together with additional data such as the requested and approved purchase amounts, reasons for declining authorization, etc., is sent to the communication device.

In some embodiments of the invention, a final fueling authorization will not be made, even after receiving vehicle, payment and nozzle authorizations and identifying that the nozzle is inserted in the pre-authorized vehicle's fuel inlet, until additional matching criteria are confirmed, such as the fuel type delivered by the nozzle and the fuel type accepted by the vehicle.

### Continued Monitoring of Fuel Nozzle

According to some embodiments of the invention, prior to authorizing the fuel dispensing transaction and during the fueling process, the fuel inlet monitoring system verifies that the nozzle is inserted into the authorized vehicle. Alternatively, throughout the fueling process, the fuel inlet monitoring system verifies that the nozzle has not been removed from the fuel inlet of the authorized vehicle. In some embodiments of the invention, the fuel inlet monitoring system verifies throughout the fueling process that it continues to simultaneously obtain images of the nozzle which is inserted into the vehicle, and images of the vehicle that was authorized. Optionally, the fuel nozzle 110 is constantly monitored, throughout the authorization and fueling process, by at least one camera 102 for identification of the nozzle itself and its relative location.

According to some embodiments of the invention, the relative location of the nozzle is determined to be in one of a series of possible locations. In an exemplary embodiment, the series of possible locations of the nozzle includes:

1. in cradle of fuel dispenser 116;
2. in close proximity of cradle of fuel dispenser 116;
3. between cradle of fuel dispenser 116 and vehicle;
4. in close proximity of vehicle fuel inlet 112; and
5. inserted in vehicle fuel inlet 112.

According to some embodiments of the invention, the direction of the movement of the fuel nozzle 110 is also constantly identified. Optionally, the direction of the movement of the fuel nozzle is determined to be one of a series of possibilities. In an exemplary embodiment, the series of possible directions of the movement of the nozzle includes:

1. toward the vehicle;
2. toward the vehicle fuel inlet 112;
3. away from the vehicle fuel inlet 112; and
4. toward the cradle of fuel dispenser 116.

According to some embodiments of the invention, camera 102 creates video and/or consecutive images at short designated intervals of time, of nozzle 110, fuel cable 114, and/or vehicle 120 until vehicle 120 is identified and authorized and nozzle 110 is determined to be inserted into vehicle 120. Optionally, camera 102 continues to create video, and/or consecutive images at short designated intervals of time, to verify that the vehicle is not moving and/or is in the same location as it was at the time vehicle authorization was made. In an exemplary embodiment of the invention, camera 102 continues to create images of the nozzle throughout the fueling process and, when necessary, provides fueling alerts to the client and/or a third party fuel control system.

### Alert Mechanism

In some embodiments of the invention, an automatic alert signal will be sent to one or more of the remote server, onsite computer running local software and the third party fuel control system, when fuel nozzle 110 is removed from the identified vehicle's fuel inlet 112 after it has been determined that fuel nozzle 110 was inserted inside vehicle fuel inlet 112 and prior to completion of fuel dispensation or upon the occurrence of other pre-defined events.

In some embodiments of the invention, the automatic alert signal is sent to at least one of the fuel dispenser, the vehicle fueling service station's local computer system, the operator of the fueling service station, the camera's internal computer, an on site computer located at the fuel service station, a remote computer, the appointed representative of the entity paying the cost of the fueling and the vehicle operator.

In some embodiments of the invention, the alert signal indicates the exact nature of the alert from a selection of pre-determined alert messages, including “nozzle disengaged from fuel inlet prior to termination of fuel dispensing.” In some embodiments of the invention, upon receipt of the alert signal, the local computer, the onsite computer running local software and/or the third party fuel control system will automatically suspend or terminate the fuel dispensing. Optionally, the alert signal is forwarded to a third party device, such as a cellular phone, via a text message, email message or application, for action. In an exemplary embodiment of the invention, the alert signal is used for information only and is stored and/or passed onto a third party or device.

In some embodiments of the invention, the automatic alert signal will be sent when the fuel inlet monitoring system ceases to create images of the vehicle's unique identifier, or the nozzle, or both, even if the fuel inlet monitoring system cannot ascertain that the nozzle 110 has been removed from the identified vehicle's fuel inlet 112 prior to completion of fuel dispensation. Optionally, the alert signal is sent only when the cessation of images of the identifier or the nozzle continues beyond the expiration of a predefined amount of time (such as 3 seconds). Optionally, in such a case, the alert signal indicates the exact nature of the alert, e.g., “nozzle out of sight” or “vehicle out of sight”.

In an exemplary embodiment of the invention, the alert signal also generates an immediate or a delayed audio alert, visual alert, and/or another attention grabbing event in the refueling facility.

In some embodiments of the invention, at least one recipient of the alert has the ability to manually terminate fuel dispensing. In some embodiments of the invention, the fuel inlet monitoring system automatically terminates the fuel dispensing upon the receipt of the alert signal. In an exemplary embodiment of the invention, the fuel inlet monitoring system prevents fraudulent dispensing of fuel and prevents the safety hazard that would be created by fuel being dispensed to a location other than into a fuel inlet of a vehicle.

In some embodiments of the invention, after the fuel inlet monitoring system automatically terminates the fuel dispensing upon the receipt of the alert signal, at least one recipient of the alert has the ability to override the termination of the fuel dispensing.

In some embodiments of the invention, the fuel inlet monitoring system is not integrated with a third party fuel control system.

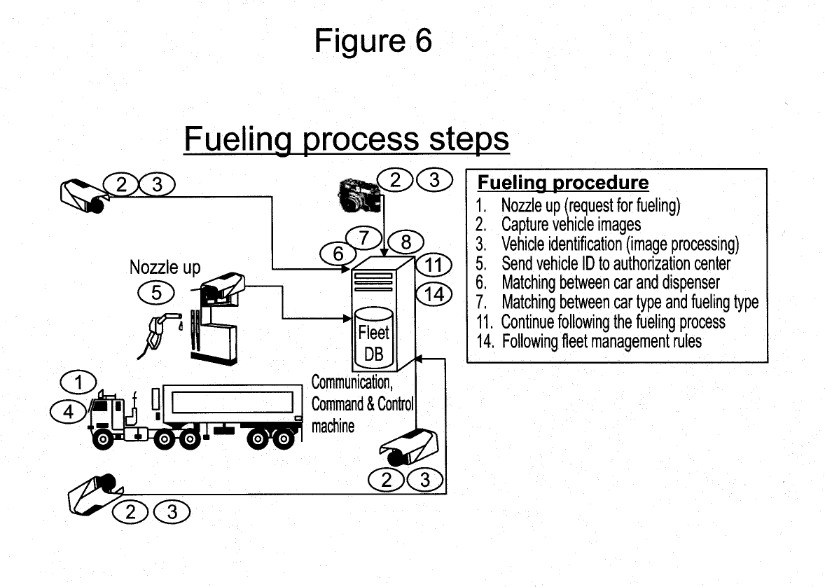

FIG. 6 illustrates methods of fueling according to some embodiments of the invention where matching the vehicle type and fueling type is required.

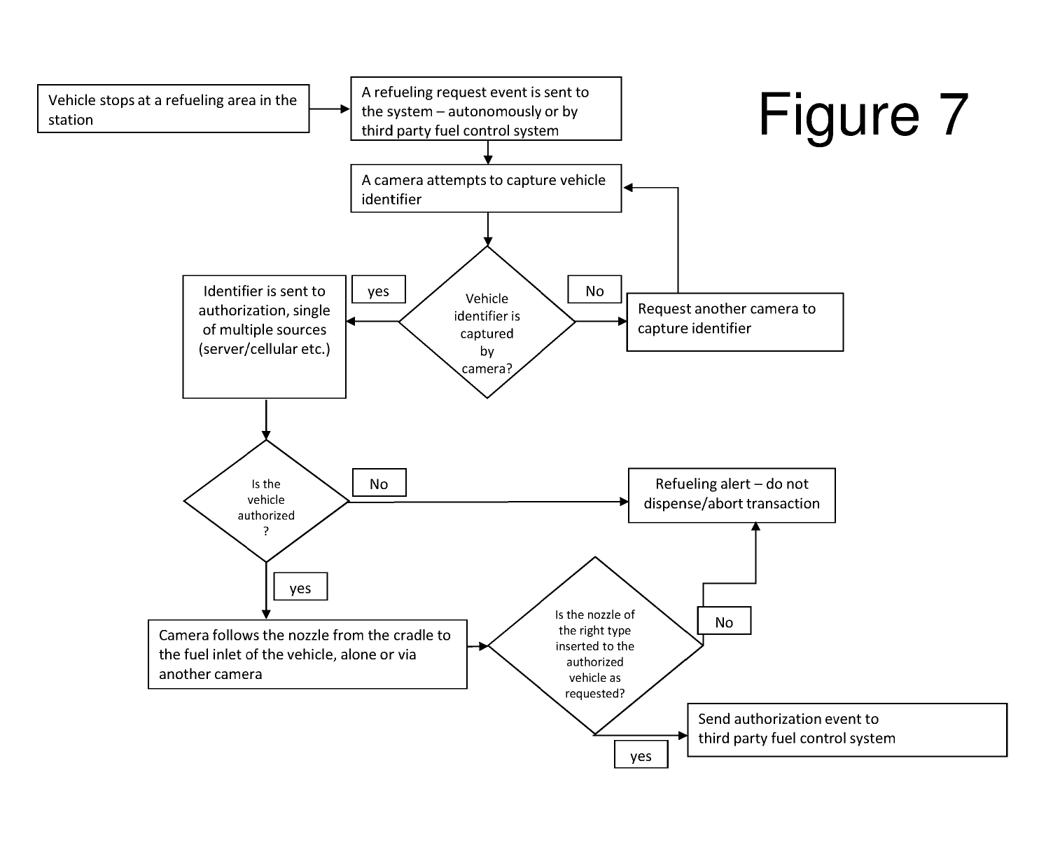

FIG. 7 illustrates the steps, in the form of a flow chart, leading to authorization, rejection or termination of a fuel purchase according to some embodiments of the invention. FIG. 7 further illustrates a fuel inlet monitoring system according to some embodiments of the invention where an automatic alert signal is activated when a nozzle of the correct type is not inserted into the authorized vehicle within a predetermined amount of time following the approval of a refueling request event and/or a request by the fuel inlet monitoring system to insert the fuel nozzle inside the fuel inlet.

As will be appreciated by one skilled in the art, aspects of some embodiments of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider.

Some aspects of the present invention are described elsewhere in this document with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

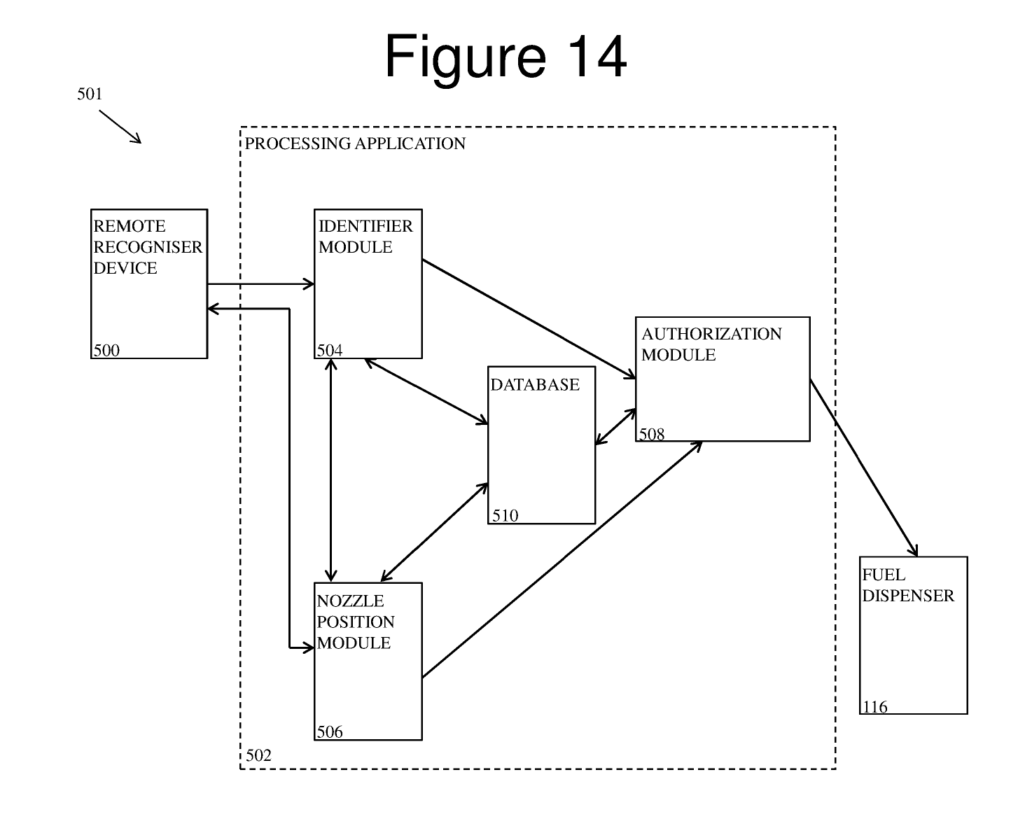

Referring now to FIG. 14 which illustrates a system diagram of some embodiments of the fuel inlet monitoring system. The fuel inlet monitoring system 501 includes a remote recognizer device 500, a processing application 502 and a fuel dispenser 116. Remote recognizer device 500 provides collected data, for example

visual images, to processing application 502. Processing application 502 analyzes the collected data and ascertains whether the fuel nozzle is inserted inside a vehicle tank inlet or not. In some embodiments, processing application 502 then authorizes (or not) the fuel dispenser 116 to dispense fuel.

Remote recognizer device 500, (e.g. as described elsewhere in this document) can comprise for example one or more devices, including imaging devices such as camera/s.

In some embodiments, processing application 502 comprises a nozzle position module 506. In some embodiments, processing application 502 comprises an authorization module 508. In some embodiments, processing application 502 comprises an identifier module 504. In some embodiments, processing application 502 comprises a database 510.

Nozzle position module 506 analyses data received from remote recognizer device 500 and provides a signal to authorization module 508, the signal describing whether fuel nozzle 110 is inserted into fuel tank inlet 112 or not. If remote recognizer device 500 includes imaging device/s, nozzle position module 506 can include an image processing application.

In some embodiments nozzle position module 506 can access and/or receive from database 510 data, such as data indicating objects to expect in the image, for example, one or more than one part of the general list of vehicle fueling service station identification information.

In some embodiments nozzle position module 506 can direct remote recognizer device 500 in order to obtain data: For example, (e.g. as described elsewhere), if the remote recognizer device includes a camera, nozzle position module 506 can instruct the camera to zoom in a particular direction in order to obtain more detailed nozzle position data.

In some embodiments identifier module 504 analyses information received from remote recognizer device 500 and identifies the vehicle and/or vehicle driver and/or vehicle passenger. Upon identifying (or not) the vehicle, identifier module 504 can provide a signal to authorization module 508. In some embodiments identifier module 504 identifies the client optionally by identifying the vehicle and/or vehicle driver and/or vehicle passenger. Upon identifying (or not) the client identifier module 504 can provide a signal to authorization module 508. In some embodiments identifier module 504 can access and/or receive information from database 510. For example, identifier module 504 can access and/or receive one or more than one part of the specific list of vehicles authorized to receive fuel after being optically identified by the fuel inlet monitoring system (e.g. the license plate number of the vehicle, the Vehicle Identification Number (VIN) of the vehicle, the location of a decal placed on the vehicle). Identifier module 504 can use information from database in order to identify the vehicle and/or vehicle driver and/or vehicle passenger.

Alternatively, identifier module 504 identifies the vehicle on the basis of information provided by a payment module (not illustrated). The payment module can access and/or receive information, including vehicle identification information and/or payment information from an independent payment system. Examples of information which can be accessed or received from a payment module include RFID tag identifier, credit card details, debit card details, information from a fuel card processor, information from an automated or manual cash payment system, or information from another payment system.

In some embodiments, nozzle position module 506 can access and/or receive information from identifier module 504 for example vehicle model, color etc, and use this information in order to ascertain the position of the fuel nozzle.

Upon receiving a signal from nozzle position module 506 and optionally a signal from identifier module 504 authorization module 508 can authorize fuel dispenser 116 to dispense fuel. In some embodiments, authorization module 508 can access and/or receive additional information e.g. payment information, the maximum amount of fuel authorized to be delivered within a pre-determined period of time, from database 510 in order to authorize fuel dispenser 116 to dispense fuel. Authorization module 508 is optional as fuel dispensing can be allowed in all circumstances, remote recognizer device 500 and processing application collecting data regarding vehicles and fueling.

In one embodiment processing application as illustrated is located on a local computer 130. Alternatively, in one embodiment, nozzle position module 506 and optionally identifier module 504 are incorporated with remote recognizer device 500 in a single device, for example, (e.g., as described elsewhere) where camera 102 includes a built-in computer.

As will be apparent to one knowledgeable in the art one or more than one of modules 504, 506 and 508, and database 510, can alternatively be provided as part of a separate application. Each module or application can be local, for example hosted by local computer 130, or hosted remotely, for example by remote server 446. Distributed module architectures are also envisioned and encompassed.

Although one database 510 is illustrated in FIG. 14, as will be apparent to one knowledgeable in the art, the system may include more than one database and each module may include a separate database. Database/s can be local, e.g. stored within camera 102 built-in computer or remote, e.g. stored within independent computer 130 which operates in a cloud environment.

In some embodiments, upon a refueling request event authorization module 508 receives a signal from nozzle position module 506 and optionally a signal from identifier module 504. Authorization module accordingly authorizes (or not) the fuel dispenser to dispense fuel. The authorization module can access and/or receive additional information from database 510 in order to make an authorization decision.

In some embodiments authorization module 508 is a third party fuel control system 450 or authorization module 508 is located on a local computer, located on a remote server 446 or an independent computer 130.

In some embodiments clients' payment information is located on database 510, such that when identifier module 504 identifies the vehicle/driver/passenger payment authorization is automatic. In other embodiments payment module 512 interfaces with payment methods or directly with clients and payment module can provide payment information to authorization module 508. Authorization module 508 can make the authorization decision additionally based on information accessed and/or received from payment module 512. In some embodiments for some clients payment information is located on database 510 and for other clients payment information is accessed from and/or provided by payment module.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Second Embodiment

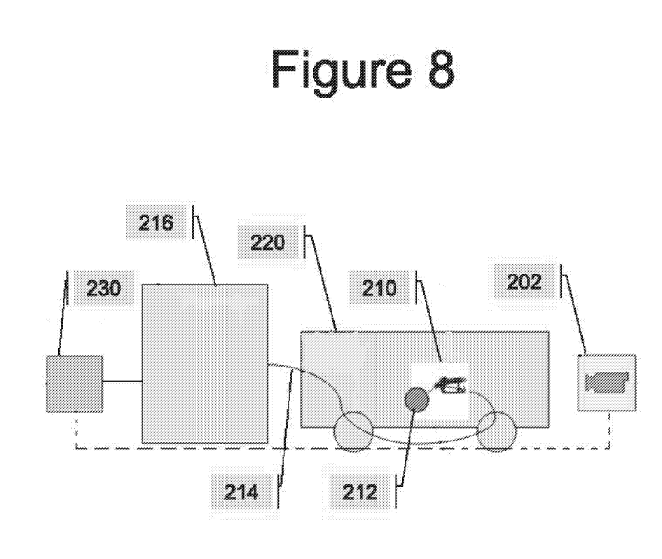

FIG. 8 illustrates a fuel inlet monitoring system containing at least one camera 202 which is not hardwired to the rest of the fuel inlet monitoring system, according to some embodiments of the invention. Optionally, the at least one camera which is not hardwired to the rest of the fuel inlet monitoring system, is not mounted. Optionally, the at least one camera which is not mounted is a portable camera. Optionally, the portable camera is a mobile phone camera.

In some embodiments of the invention, Camera 202 is a cell phone camera. Optionally, Camera 202 is wirelessly connected to the fuel inlet monitoring system, as depicted by the dotted line between camera 202 and independent computer 230. Optionally, the cell phone camera may be owned by the fuel service station or by the driver or passenger of the vehicle. In an exemplary embodiment of the invention, the cell phone camera may be operated by an employee of the fuel service station or by the driver or passenger of the vehicle.

According to some embodiments of the invention, at least one imaging device is an existing camera in the vehicle fueling service station. In some embodiments of the invention, at least one imaging device is a camera specially used in the vehicle fueling service station as part of said fuel inlet monitoring system. Optionally, at least one imaging device is a plurality of cameras comprising at least one existing camera in the vehicle fueling service station and at least one camera specially used in the vehicle fueling service station as part of said fuel inlet monitoring system.

### Third Embodiment

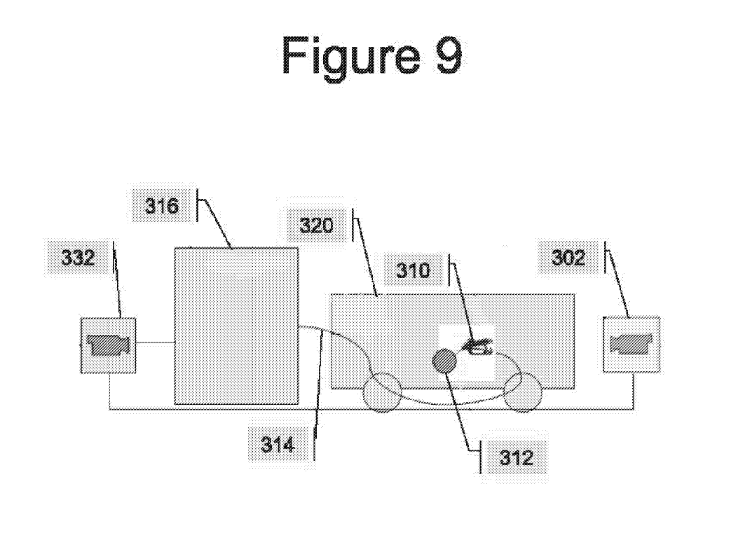

FIG. 9 illustrates a fuel inlet monitoring system according to some embodiments of the invention. Additional camera 332 is utilized together with at least one camera 302 to enable an accurate identification of the nozzle, the vehicle and the fuel inlet located in the vicinity of at least one fuel dispensing pump.

According to some embodiments of the invention, at least one camera 302 is configured to communicate with at least one other camera 332, directly or indirectly, before, during and/or after creating images of vehicle 320, fuel inlet 312 and nozzle 310. Optionally, this communication between cameras increases the diversity of images that are obtained. In an exemplary embodiment of the invention, this communication between cameras decreases the amount of overlap and/or redundancy between images obtained by the different cameras.

According to some embodiments of the invention, the communication between cameras broadens the angles from which the images are obtained. Optionally, the communication broadens the range of views obtained in the images. Optionally, the communication generates the creation of additional images of the same area as that obtained in another image. In an exemplary embodiment of the invention, the creation of additional images of the same area assists the image processing application in analyzing the area.

According to some embodiments of the invention, existing cameras at a service station are utilized as camera 302 and/or camera 332. Optionally, existing cameras at a service station are utilized in combination with camera 302 and/or camera 332 as a third camera, fourth camera, etc.

In an exemplary embodiment, additional cameras are added to the service station in a sufficient number to enable a quick and accurate identification of a vehicle, its fuel inlet and a fuel nozzle and to determine whether the fuel nozzle is inserted inside the fuel inlet. Optionally, at least one camera 302 is a cell phone camera or other portable camera.

### Fourth Embodiment

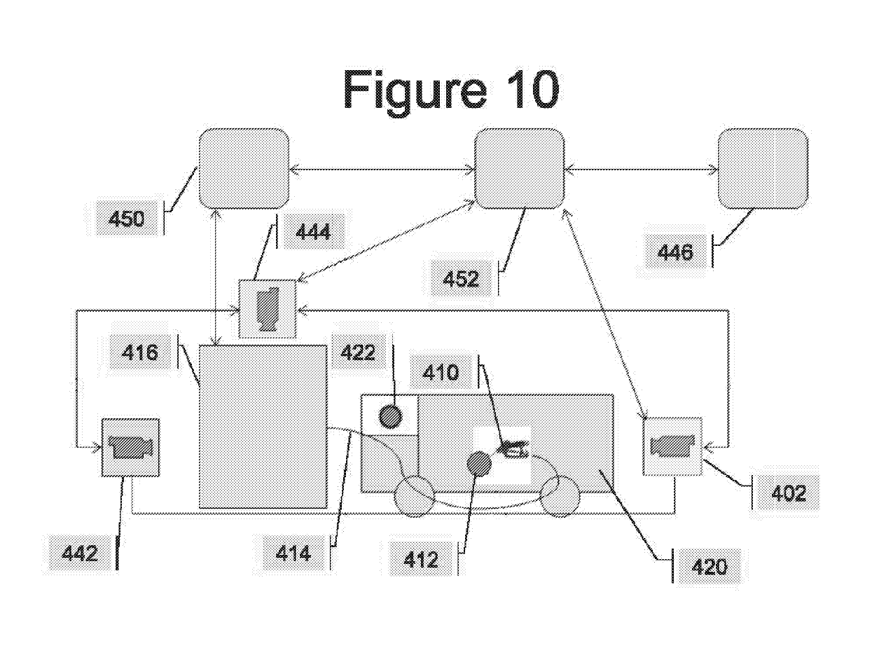

FIG. 10 illustrates a fuel inlet monitoring system in which the fuel inlet monitoring system is integrated with a third party fuel control system, according to some embodiments of the invention. At least one camera 444 is installed at a position that provides a view of vehicle 420 and transmits that image to a computer which identifies the vehicle and establishes for it a unique ID number. Optionally, camera 444 creates an image of at least one of a bar code sticker 422, an RFID tag or another unique identifier such as the plate number or Vehicle Identification Number of vehicle 420, and transmits it an internal computer located in camera 402, to an onsite computer 452 running local software, and/or to a remote server 446 for interpretation.

According to some embodiments of the invention, the computer sends the unique ID number and/or the interpretation of the obtained images for authorization to a third party fuel control system 450 and/or remote server 446. Optionally, independent computer 452, which may be onsite and run local software, both interprets the obtained images and makes an authorization decision.

An additional embodiment includes a fuel inlet monitoring system that is integrated with a driver identifier in addition to, or in place of, identification of a vehicle. Optionally, the unique identifier is a refueling card/credit card, an RFID tag or another payment means or identification device. In an exemplary embodiment of the invention, the payment means is presented by a non-driver accompanying the vehicle, such as a passenger.

According to some embodiments of the invention, the refueling card/credit card, RFID tag or other payment means or identification is presented to a third party fuel control system, directly or via proxy, (e.g., via payment processing equipment at the pump, at the service stations store, at the Point of Sale, at the service station back office, etc.), causing the fuel inlet monitoring system to recognize that a refueling request event has occurred.

According to some embodiments of the invention, the third party fuel control system may pre-authorize the transaction based on the payment means received, may reject the authorization request, in which case fueling will not authorized using the payment means presented, or may take another step, as warranted.

According to some embodiments of the invention, the computer integrated with cameras 402, 442 and/or 444, and/or the remote server, matches the vehicle identification information with the payment means received and/or with information contained in a data base and/or with information contained in a third party fuel control system.

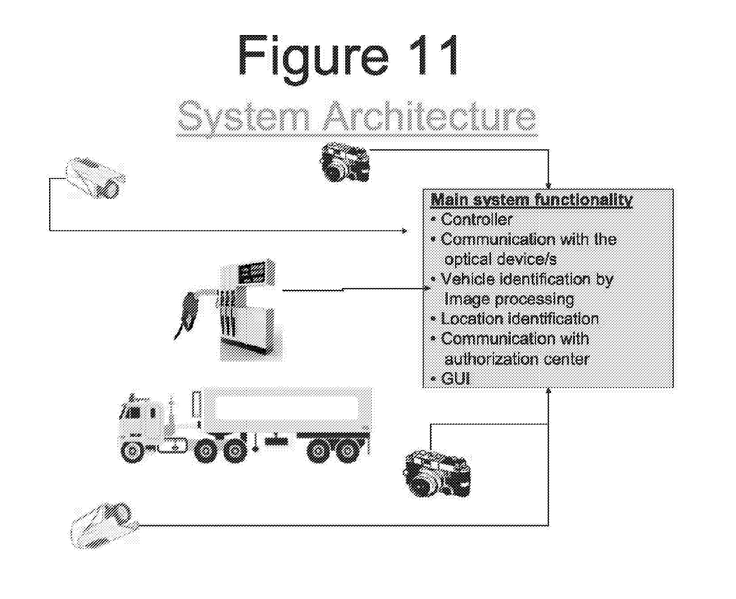

FIG. 11 illustrates different parts of the system architecture in which at least one portable camera is utilized. For example, two portable cameras are shown as well as two mounted cameras. As listed in the legend to FIG. 11, the fuel inlet monitoring system maintains communication between the four cameras and an authorization center. Images are transferred from the cameras to the authorization center and the vehicle is identified by image processing. The location of the fuel tank inlet is identified. Optionally, the system utilizes a graphical user interface (GUI) to facilitate interaction with the system.

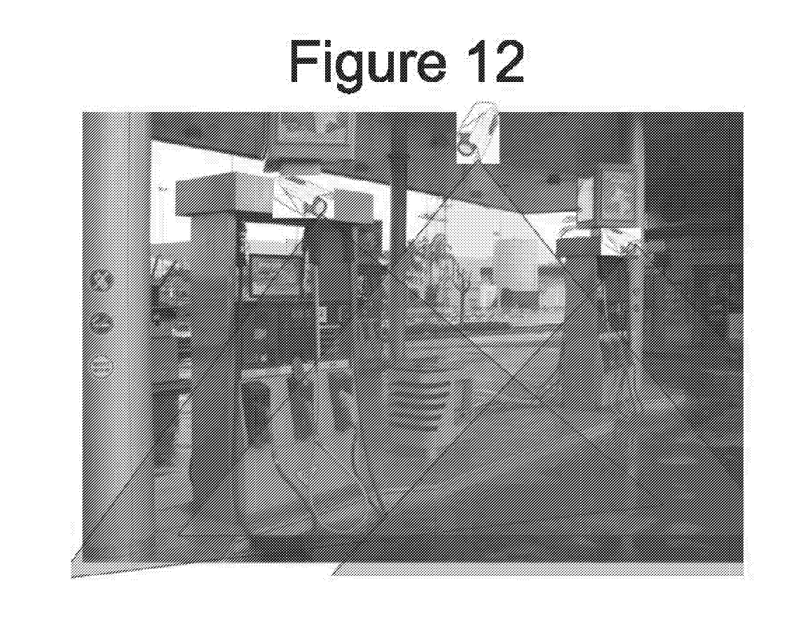

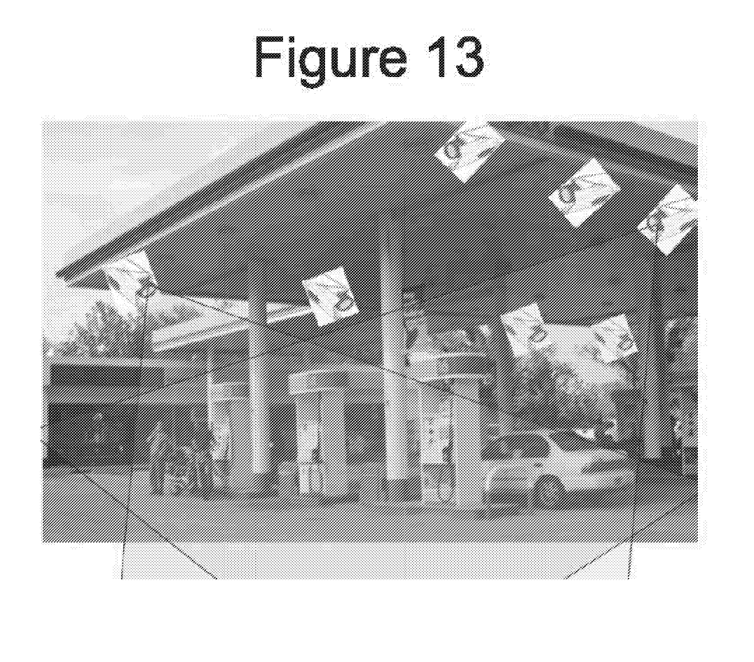

FIGS. 12 and 13 illustrate potential locations for the placement of cameras and their coverage according to some embodiments of the invention. For example, FIG. 12 shows a vehicle fueling service station with three mounted cameras, each at a height equal to or above the height of the fuel dispensing pump. The range of each camera is illustrated with a triangle emanating from the camera in the direction of the orientation and angle of the camera. Optionally, the three cameras are positioned to collectively cover the entire area from the fuel dispensing pump to the probable location of a vehicle during fueling. In an exemplary embodiment, the entire area is viewable by the cameras from the ground up to a height equal to the roof of the vehicle. The range of each camera is illustrated with a triangle emanating from the camera according to the orientation and angle of the camera. Optionally, the three cameras are positioned to collectively image the entire area from the fuel dispensing pump to the probable location of a vehicle during fueling. In an exemplary embodiment, the entire area is viewable by the cameras from the ground up to a height equal to the roof of the vehicle.

In another example, FIG. 13 shows a vehicle fueling service station with seven mounted cameras, each located at a different position on the roof of a rain shelter located above the fuel dispensing pumps. The ranges of the cameras located at the far left side of the roof of the rain shelter and at the middle of the right adjacent side of the roof of the rain shelter are illustrated with triangles emanating from the cameras according to the orientations and angles of the cameras. Optionally, the three cameras are positioned to collectively cover the entire area from the fuel dispensing pump to the probable location of a vehicle during fueling. In an exemplary embodiment, the entire area is viewable by the cameras from the ground up to a height equal to the roof of the vehicle. Optionally, these two cameras are positioned to collectively cover the entire area from the three fuel dispensing pumps on the left side of the vehicle fuel service station, labeled 12, 14 and 16 in FIG. 13, to the probable location of a vehicle during fueling at any of those three pumps. In an exemplary embodiment, the entire area is viewable by the cameras from the ground up to a height equal to the roof of the vehicle. Optionally, the entire area of the all of the fuel dispensing pumps located at the vehicle fueling service station is viewable by said cameras.

According to some embodiments of the invention, each vehicle that enters the fuel dispensing facility is scanned by at least one camera installed on the ceiling of the fuel dispensing station, on the fuel dispensers, or in other locations. Optionally, at least one of cameras and other devices comprising the fuel inlet monitoring system communicate with each other in order to share data. Optionally, the cameras are installed to create coverage of the area around only one fuel dispenser 416 in a fuel service station. In an exemplary embodiment of the invention, the cameras are installed to create coverage of more than one fuel dispenser 416 in a fuel service station.

### Example

As an example of the fuel inlet monitoring system, according to some embodiments of the invention, the operator of the vehicle or an employee of the fueling service station removes the fuel delivery nozzle from the fuel dispensing pump and the fuel inlet monitoring system is then automatically activated and provides images of the vehicle using cameras located on the fuel dispensing pump side of the vehicle, one overhead camera located over the middle of the vehicle and one overhead camera located to the rear of the vehicle. The camera to the rear of the vehicle identifies the license plate number of the vehicle. The image processing application determines from the remote database the vehicle's model listed in connection with that license plate and determines the location of the center of the fuel tank inlet to be, for example, 1.1 meters inwards from the rear of the driver's side of the vehicle and 0.8 meters below the roof of the vehicle. The image processing application then analyzes the image from the side camera and determines the geometry of the vehicle, which indicates that the front of the vehicle is to the left when facing the vehicle from the fuel dispensing pump. The image processing application then uses information about inlet or nozzle location to choose to which part of the image to provide a physical zoom and/or pan and commands the side camera and overhead camera located over the middle of the vehicle to provide zoom images of the expected range of the location of the vehicle fuel tank inlet, for example, within 0.2 meters from the center point indicated to be 1.1 meters inwards from the rear of the driver's side of the vehicle and 0.8 meters below the roof of the vehicle. The system uses information about inlet or nozzle location to choose which part of the images to process and determines that the side camera zoom image indicates that the back of the fuel delivery nozzle is located within the expected range of the fuel tank inlet and that the front of the fuel delivery nozzle does not appear. The overhead camera, however, provides a zoom image indicating that the front of the fuel delivery nozzle is actually pointed down below the expected range of the location of the fuel tank inlet and further indicates the presence of a portable container below the front of the fuel delivery nozzle. The system is programmed to generate a signal only when the fuel delivery nozzle is inserted inside the fuel tank inlet. The signal is not generated and a fueling authorization is not issued. Optionally, the range for the location of the fuel tank inlet is within 0.4 meters of the expected center point of the inlet. Optionally, the range for the location of the fuel tank inlet is within 0.1 meters of the expected center point of the inlet.

In a continuation of the example, the operator of the vehicle then inserts the fuel delivery nozzle inside the fuel tank inlet and a signal indicating that the fuel delivery nozzle is inserted inside the fuel tank inlet is generated. The system confirms that the vehicle has not gone over its hourly, daily or weekly fuel limits and that the fueling request is taking place at an authorized time and day. The system further confirms that pre-authorized payment is established for the vehicle and fueling is authorized and the fuel pump begins dispensing fuel. After a few seconds, however, the fuel delivery nozzle is removed from the fuel tank inlet and again placed inside a portable container. The system continues providing images every 2 seconds and the overhead camera provides an image indicating that the fuel delivery nozzle is no longer inserted inside the fuel tank inlet. An alert signal, different than the original signal, is then generated indicating that a previously inserted nozzle is no longer inserted inside the fuel tank inlet. The alert signal is sent by the system to the fuel dispensing pump which is pre-programmed to stop fuel dispensing upon receipt of an alert signal. Fuel dispensing is stopped and an automated message is sent to the entity paying for the fuel dispensing via a text message detailing the time of the initial fueling request, the initial authorization of fueling, the time of the alert signal, the reason for the alert signal, the time fueling was stopped and the amount of fuel that was dispensed. The message contains directions for the recipient of the message to override the fuel termination by sending a return text stating “authorization override.” The recipient sends the “authorization override” text message. The system passes the authorization override message onto the local service station manager by text message with a message indicating that they must also respond with an “authorization override” text message, but only after ascertaining that the fuel is being dispensed in a lawful and safe manner. The service station manager approaches the vehicle and upon seeing that the fuel delivery nozzle is inserted in a portable container checks the container. After ascertaining that the portable container does not meet legal requirement for use in a fueling service station, the manager sends a message declining to override the authorization system. A full report with images is then sent to the entity paying for the fueling.

It is expected that during the life of a patent maturing from this application many relevant optic and image recognition technologies will be developed and the scope of the terms optic recognition and image recognition are intended to include all such new technologies a priori.

The terms “comprises,” “comprising,” “includes,” “including,” “having” and their conjugates mean “including but not limited to.”

The term “consisting of means” including and limited to.”

The term “consisting essentially” of means that the composition, method or structure may include additional ingredients, steps and/or parts, but only if the additional ingredients, steps and/or parts do not materially alter the basic and novel characteristics of the claimed composition, method or structure.

The term “as described elsewhere” refers to description within this document.

As used herein, the singular form “a,” “an” and “the” include plural references unless the context clearly dictates otherwise. For example, the term “a camera” or “at least one camera” may include a plurality of cameras.

The term “refueling process” means the whole set of events that occur from a refueling request to finalizing the transaction's details—end of transaction (vehicle, quantity, fuel type, time and day, location, price, any additional information).

The term “end of transaction” means an event that occurs when a) a nozzle is returned to its cradle, b) when fuel flow has stopped for a predefined period of time, c) when the automation system terminates the transaction automatically, or d) when the transaction is terminated manually.

The term “nozzle information” means unique nozzle mapping of all the nozzles in the station. Each nozzle receives a unique ID indicating the fuel pump to which the nozzle is related, nozzle location at the pump, the product provided by that nozzle.

The term “refueling alerts” means alerts that are generated when predefined behaviors occur, e.g., a) a nozzle of the wrong type is inserted into a vehicle (diesel nozzle inserted into a gasoline vehicle), b) a nozzle is out of sight and it is difficult to determine if it is indeed inserted into the vehicle, c) a vehicle is out of sight and it is difficult to determine if the nozzle is indeed inserted into that vehicle, d) a nozzle is removed from the vehicle, e) a vehicle is removed from the nozzle, f) a nozzle is inserted into a vehicle that was not authorized and g) a person is interfering with the refueling process.

The term “refueling position” means the position in which a vehicle is stopped in order to refuel.

The term “autonomous recognition of a refueling request event” means camera 102 or simple camera 1204 is installed in a manner that allows it view of the pump and nozzles. For example, camera 102 is installed above the pump. Each nozzle is predefined by the fuel inlet monitoring system: nozzle number, pump number, fuel type provided by this nozzle. This mapping resides at remote server 101 or an onsite computer running local software 102 or third party fuel control system 105 or all. Each nozzle can be marked by unique identifier 106. Camera 102, or simple camera 104 and an onsite computer running local software 102 and/or remote server 101 maps the nozzles position, and provides an alert to remote server 101 or an onsite computer running local software 102 once a nozzle is removed from the cradle/the space recognized as a cradle.

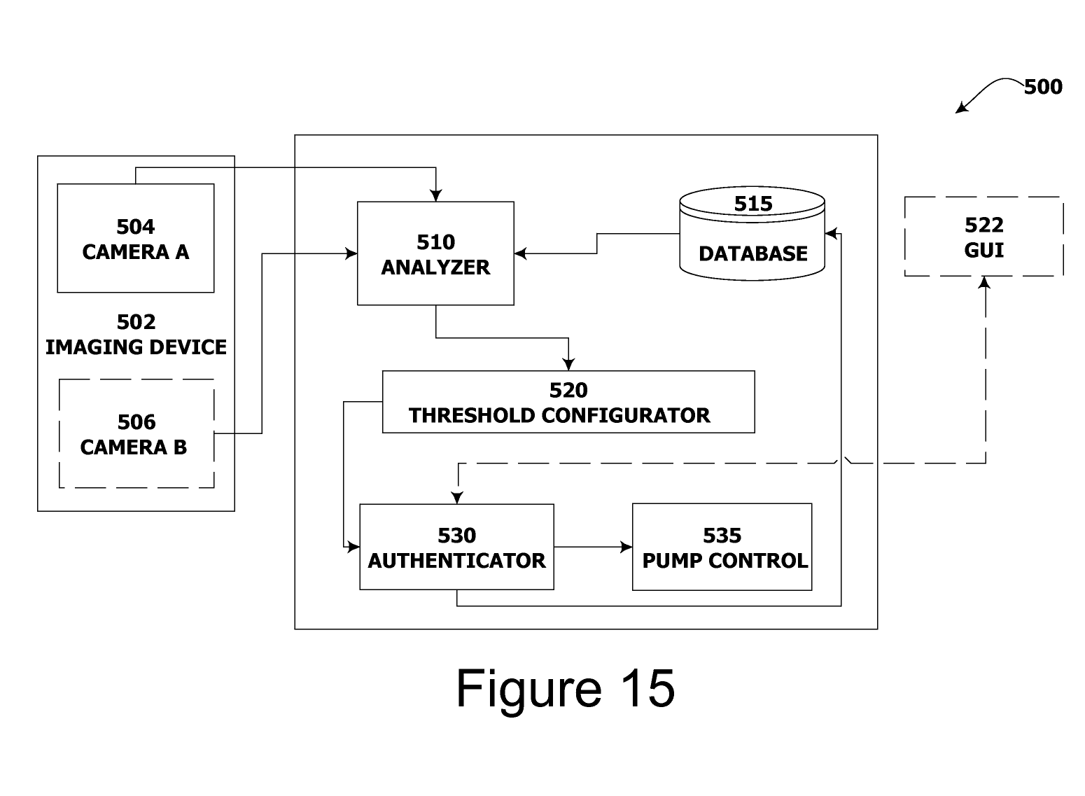

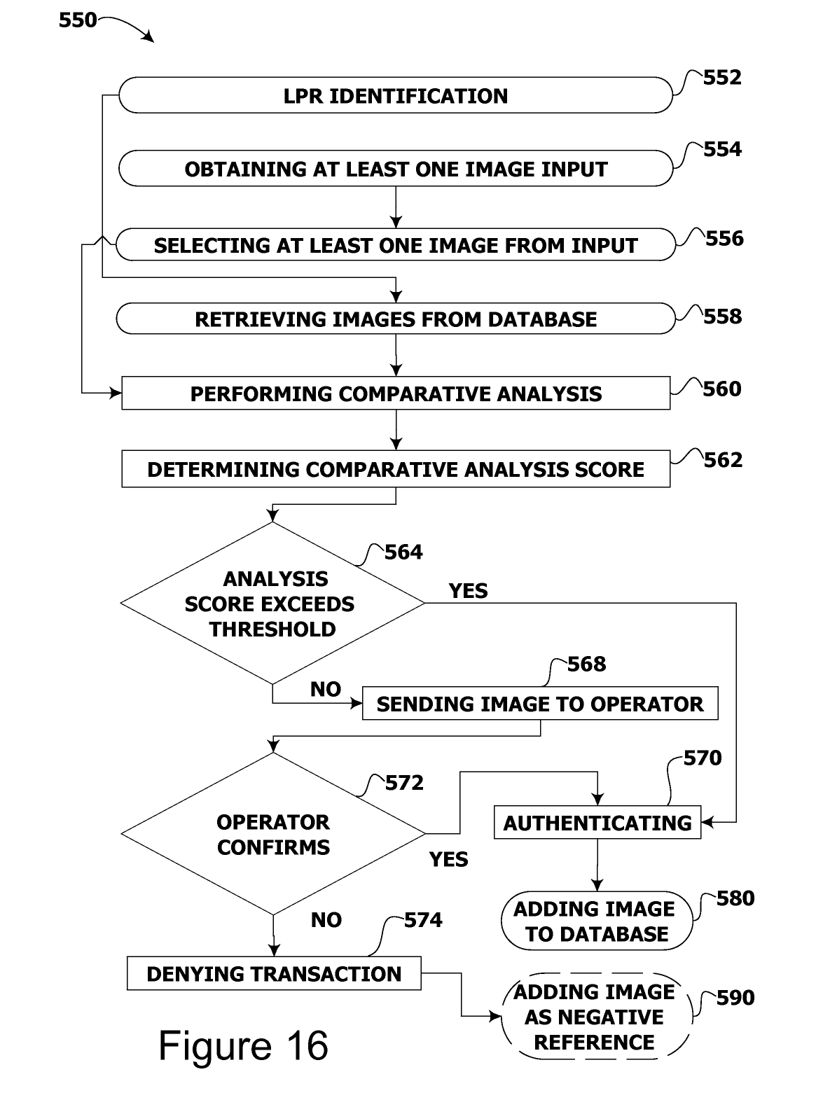

In accordance with some embodiments of the present invent, reference is now made to FIGS. 15 and 16, showing a schematic block diagram of system 500 as well as a high level flowchart diagram of method 550 of image processing and verification for a purchase authorization associated with fuel dispensing.

System 500 for image processing and verification for a purchase authorization of fuel transaction shown in FIG. 1 comprises imaging device 502. Imaging device 502 is implemented in step 554 and/or 552 of method 550 of image processing and verification for a purchase authorization associated with fuel dispensing shown in FIG. 2. Imaging device 502 comprises at least one camera 504. Camera 504 is optionally a Complementary Metal-Oxide-Semiconductor (CMOS) sensor. In some embodiments of the invention, camera 504 is a charge-coupled device (CCD).

Optionally, imaging device 502 is positioned in a fuel service station at a height and angle to facilitate imaging of a license plate located on the back of the vehicle (not shown) refueling at fuel dispenser pump (not shown). For example, imaging device 502 may be placed at a height of between 0 and 4 meters above the ground and oriented toward the probable location of license plate location on the rear of the vehicle when the driver's side of the vehicle is closest to the fuel dispensing pump.

In an exemplary embodiment of the invention, imaging device 502 optionally comprises second camera 506. Both cameras 504 and 506 of imaging device 502 are used, with one on each side of the vehicle, so that at least one is oriented towards the probable location of the fuel tank inlet, which may be on different sides of various vehicles.

According to some embodiments of the invention, camera 504 is positioned above the fuel dispensing area at a height and angle to facilitate imaging of the fuel inlet on the vehicle as well as of the fuel nozzle attached to fuel conduit emanating from the fuel dispenser pump. In addition to creating images of the fuel nozzle and the fuel inlet, camera 506 and/or an additional camera (not shown) is positioned to create an image showing the fuel nozzle is inserted inside fuel inlet. For example, camera 506 may be placed at a height of between 0 and 6 meters above the ground and oriented toward the probable location of the fuel inlet of the vehicle at an angle of between 20 and 160 degrees to the perpendicular. In an exemplary embodiment, the height is 1 meter and the angle is 90 degrees.

According to some embodiments of the invention, two cameras 506 are used, with one on each side of the fuel dispensing pump so that one is oriented toward the probable location of the fuel tank inlet, while the vehicle is closest to the fuel dispensing pump on one side of the dispensing pump or another side of the dispensing pump.

According to some embodiments of the invention, two cameras 506 are used, on each side of the fuel dispensing pump, so that one camera 506 is oriented toward the probable location of the fuel tank inlet, when the vehicle is oriented forwards relatively to the fuel dispensing pump, while the other camera 506 is oriented toward the probable location of the fuel tank inlet, when the vehicle is oriented backwards relatively to the fuel dispensing pump.

According to some embodiments of the invention, additional camera (not shown) is positioned above the fuel dispensing area at a height and angle to facilitate imaging of the fuel conduit and fuel dispenser pump in order to create images of the fuel nozzle in fuel inlet, which cameras 505 and 506 are not able to obtain. For example, the additional camera (not shown) may be placed at a height of between 1.5 and 10 meters above the ground and oriented toward the area from the fuel dispenser pump to the vehicle, at an angle of between 20 and 160 degrees to the perpendicular. In an exemplary embodiment, the height is 3 meters and the angle is 35 degrees.

According to some embodiments of the invention, system 500 for image processing and verification for a purchase authorization of fuel transaction comprises analyzer 510. The images obtained by imaging device 502, using cameras 504, 506 and/or other cameras (not shown) at step 554 and/or 552 of method 550 are analyzed by analyzer 510, to ascertain the identity of the objects contained within the images. Optionally, cameras 504, 506 and/or other cameras (not shown) are able to transmit images to analyzer 510 and/or to a computer in a separate location. If the images obtained by imaging device 502, using cameras 504, 506 and/or other cameras (not shown) at step 554 and/or 552 of method 550 comprise a plurality of images, an individual image is preselected by analyzer 510 at step 556 from the set of images obtained at step 554 for further analysis.

Analyzer 510 optionally comprises a license plate recognition (LPR) module. LPR module is configured to recognize the registration number of the vehicle, typically by applying an optical character (OCR) algorithm to the images obtained by imaging device 502, using cameras 504, 506 and/or other cameras (not shown). LPR module is implemented in step 552 of method of image processing and verification for a purchase authorization associated with fuel dispensing shown in FIG. 2.

According to some embodiments of the invention, system 500 for image processing and verification for a purchase authorization of fuel transaction comprises database 515. Database 515 contains a plurality of previously obtained images of the particular vehicle having the fuel nozzle inserted into the fuel inlet of the vehicle. Exemplarily the process of registration to the service of automated purchase authorization of fuel transaction according to some embodiments of the present invention comprises obtaining a plurality of images of the particular vehicle registering for service of automated purchase authorization of fuel transaction, having the fuel nozzle inserted into the fuel inlet of the vehicle. The aforementioned plurality of images of the particular vehicle registering for service of automated purchase authorization of fuel transaction are preferably taken from different distances and angles as well as using different types on fuel nozzles and various ambient light conditions.

Analyzer 510 of system 500 for image processing and verification for a purchase authorization of fuel transaction is connected to database 515. Upon recognition the registration number of the vehicle registered to the service of automated purchase authorization of fuel transaction at step 552, analyzer 510 retrieves from database 515 the respective previously obtained images of the particular vehicle having the fuel nozzle inserted into the fuel inlet of the particular vehicle at step 558.

Upon retrieving the respective images of the particular vehicle registered to the service of automated purchase authorization of fuel transaction having the fuel nozzle inserted into the fuel inlet of the vehicle from database 515 at step 558, analyzer 510 is configured to perform a comparative analysis of these images at step 560 vis-à-vis the image preselected by analyzer 510 at step 556. Exemplary comparative analysis of step 560 comprises normalizing correlation image preselected at step 556, preferably as a local normalized correlation according to shift and/or scale, against an image retrieved at step 558.

Normalizing correlation against image is exemplarily performed by analyzer 510 in the following manner. For a given image, obtained by imaging device 502 at step 554, using cameras 504, 506 and/or other cameras (not shown) and then preselected by analyzer 510 at step 556, a search window in an image retrieved from database 515 at step 558 upon recognition the registration number of the vehicle registered to the service of automated purchase authorization of fuel transaction at step 552 is defined by analyzer 510, wherein the size of the search window is typically a predefined parameter. Thereafter a search for the image, preselected at step 556, in the image retrieved from database 515 is performed within the search window boundaries. The search for the image, preselected at step 556, within in the image retrieved from database 515 at step 558 is optionally performed by analyzer 510 at step 560 so as to determine a similarity score for each possible location at step 562 for the image preselected at step 556 within the search window in an image retrieved from database 515 at step 558, under the assumed geometric transformations, for instance shift and/or scale transformations.

A preferred similarity analysis comprises a normalized cross-correlation (NCC). NCC is known in the art of image processing, typically in applications where the brightness of the image and template can vary, so that the images are first normalized. The benefits of using NCC is its robustness to support reasonable color changes and the fact NCC provides normalized score which allows to easily put a threshold on obtained result.

Exemplary NCC score of an image preselected at step 556, to the search window from an image retrieved from database 515, is determined at step 562 by subtracting the mean and dividing by the standard deviation according to Equation 1:

$$\frac{1}{n} {\sum }_{x , y} \frac{( f ( x , y ) - \overline{f} ) ( t ( x , y ) - \overline{t} )}{{σ}_{f} {σ}_{t}} \qquad Equation 1$$

where t(x, y) is the image obtained by imaging device, f(x, y) is the search window within image retrieved from database, n is the number of pixels in t(x, y) and f(x, y), f̅ is the average of f, t̅ is the average of t whereas σ_{f} is standard deviation of f and σₜ is standard deviation of t.

The cross-correlation of the image obtained by imaging device within the search window, within image retrieved from database, can be optionally determined as a dot product of two normalized vectors, if Equations 2.1 and 2.2 are satisfied.

F(x,y)=f(x,y)− f̅ Equation 2.1

T(x,y)=t(x,y)− t̅ Equation 2.2

Provided that Equations 2.1 and 2.2 are satisfied the abovementioned sum of Equation 1 can be determined by Equation 3:

$$〈 \frac{F}{‖ F ‖} , \frac{T}{‖ T ‖} 〉 \qquad Equation 3$$

where [symbol] •,• [symbol] is the inner product and ∥•∥ is the L² norm.

In order to determine the combination of two main errors, namely a shift errors and scale errors, there are actually 4 degrees of freedom to solve any X/Y correlation at step 560. In some examples, the image preselected at step 556 is transformed according to every possible shift/scale combination at step 560 and compared according to NCC to each transformation against the relevant part of the search window within the image retrieved from database 515. The shift/scale combination that attains the highest NCC score determined at step 562 is typically to be selected as a relevant transformation.

Transforming the image preselected at step 556 according to every possible shift/scale combination at step 560 and determining NCC scores at step 562 of each transformation against the relevant part of the search window within the image retrieved from database 515 is however requires a relatively high computational power. Hence, in other examples normalizing correlation against image performed by analyzer 510 at step 560 comprises an approximated process, achieved by working in a greedy manner, namely finding the best shifts for each scale and then finding maximum for the shifts in scales dimension to determine the scores of step 562.

According to some embodiments of the invention, system 500 for image processing and verification for a purchase authorization of fuel transaction comprises threshold configurator 520. Threshold configurator 520 receives from analyzer 510 the score of comparative analysis at step 560 of the image obtained by imaging device 502 and preselected at step 556, vis-à-vis the image retrieved from database 515. Threshold configurator 520 thereafter determines at step 564 whether the aforesaid score of comparative analysis exceeds a general predefined threshold for transaction or a specific threshold set for the particular vehicle registered to the service of automated purchase authorization of fuel transaction.

Threshold configurator 520 is connected to authenticator 525. Provided the aforesaid score of comparative analysis determined at step 564 exceeds a general predefined threshold for transaction or a specific threshold set for the particular vehicle registered to the service of automated purchase authorization of fuel transaction, authenticator 525 typically authenticates the transaction at step 570 and commands the control of fuel pump 535 to dispense the fuel. Upon authenticating the transaction at step 570, the image obtained by imaging device 502 and preselected at step 556 is preferably added to image database 515 at step 580 as a true positive reference, for identification of the for the particular vehicle registered to the service of automated purchase having the fuel nozzle inserted into the fuel inlet thereof, in authorization of any future fuel transactions; thereby extending the variability of the reference base for identification of the particular vehicle and enhancing the probability of true positive identifications in the future, by automatically performing accumulative machine learning over time.

If however the aforesaid score of comparative analysis determined at step 564 does not exceed a general predefined threshold for transaction or a specific threshold set for the particular vehicle registered to the service of automated purchase authorization of fuel transaction, authenticator 525 preferably sends the image to GUI 552 at step 568 to be displayed to a human operator for a supervised approval/denial at step 572. Provided that aforesaid human operator approves the transaction at step 572, authenticator 525 typically authenticates the transaction at step 570 and commands the control of fuel pump 535 to dispense the fuel. Upon authenticating the transaction at step 570, the image obtained by imaging device 502, preselected at step 556 and thereafter approved by human operator at step 572 is preferably added to image database 515 at step 580 as a true positive reference, for identification of the for the particular vehicle registered to the service of automated purchase having the fuel nozzle inserted into the fuel inlet thereof, in authorization of any future fuel transactions; thereby extending the variability of the reference base for identification of the particular vehicle and enhancing the probability of true positive identifications in the future, by automatically performing accumulative machine learning over time.

If however aforesaid human operator does not confirm at step 572, authenticator 525 typically denies the transaction at step 574 and commands the control of fuel pump 535 to not dispense the fuel. Upon denying the transaction at step 574, the image obtained by imaging device 502, preselected at step 556 and thereafter denied by human operator at step 572 is optionally added to image database 515 at step 590 as a true negative reference, for positive identification of another vehicle than the particular vehicle registered for service of automated purchase, having the fuel nozzle inserted into the fuel inlet thereof; thereby enhancing the probability of true negative identifications in the future, by performing supervised accumulative learning over time.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or, as suitable, in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental calculated support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims, including alternatives, modifications and variations incorporating features from different embodiments.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for image processing and verification for a purchase authorization associated with fuel dispensing comprises:
(a) an imaging device comprising at least one digital camera, said camera is configured to acquire at least one image of a fuel inlet of a vehicle registered to a service of said purchase authorization, wherein said at least one image comprises a fuel nozzle of a fuel pump inserted into said fuel inlet of said vehicle;
(b) a database comprising a plurality of pre-obtained images of said vehicle registered to said service of said purchase authorization, wherein said pre-obtained images comprise a fuel nozzle of a fuel pump inserted into said fuel inlet of said vehicle;
(c) an analyzer connected to said imaging device and said database, wherein:
(I) said analyzer is configured to receive said at least one image from said imaging device;
(II) said analyzer is configured to recognize said vehicle registered to said service of said purchase authorization;
(III) said analyzer is configured to retrieve from said database at least one pre-obtained image of said vehicle registered to said service of said purchase authorization;
(IV) said analyzer is configured to perform a comparative analysis of said at least one image received from said imaging device vis-à-vis said at least one pre-obtained image retrieved from said database and determine a quantitative score of said comparative analysis;
(d) an threshold configurator connected to said analyzer and receiving said score of said comparative analysis from said analyzer, said threshold configurator is configured to determine whether said quantitative score of said comparative analysis exceeds a predefined threshold;
(e) a graphical user interface connected to said threshold configurator, said graphical user interface is configured to present to an operator said at least one image received from said imaging device, wherein said quantitative score of said comparative analysis of said at least one image received from said imaging device does not exceed said predefined threshold;
(f) an authenticator functionally connected a controller of said fuel pump, said authenticator is functionally connected to said threshold configurator, said authenticator is actuated by said threshold configurator and configured command said controller of said fuel pump to dispense said fuel, wherein said quantitative score of said comparative analysis of said at least one image received from said imaging device exceeds said predefined threshold.

2. The system for image processing and verification for a purchase authorization associated with fuel dispensing as in claim 1, wherein said imaging device comprises a plurality of digital cameras, positioned at different locations.

3. The system for image processing and verification for a purchase authorization associated with fuel dispensing as in claim 1, wherein said analyzer further comprises a license plate recognition module.

4. The system for image processing and verification for a purchase authorization associated with fuel dispensing as in claim 1, wherein said analyzer further comprises a selector module configured to select said at least one image received from said imaging device from a plurality of images obtained by said imaging device.

5. The system for image processing and verification for a purchase authorization associated with fuel dispensing as in claim 1, wherein said comparative analysis of said at least one image received from said imaging device vis-à-vis said at least one pre-obtained image retrieved from said database performed by said analyzer comprises a normalized cross-correlation.

6. The system for image processing and verification for a purchase authorization associated with fuel dispensing as in claim 1, wherein said comparative analysis of said at least one image received from said imaging device vis-à-vis said at least one pre-obtained image retrieved from said database performed by said analyzer comprises a normalized cross-correlation performed according to Equation 1:
$$\frac{1}{n} {\sum }_{x , y} \frac{( f ( x , y ) - \overline{f} ) ( t ( x , y ) - \overline{t} )}{{σ}_{f} {σ}_{t}} \qquad Equation 1$$
wherein t(x,y) is said image obtained by said imaging device; f(x,y) is said image retrieved from said database; n is a number of pixels in t(x,y) and f(x,y); f̅ is an average of f; t̅ is the average of t; σ_{f} is standard deviation of f and σₜ is standard deviation of t.

7. The system for image processing and verification for a purchase authorization associated with fuel dispensing as in claim 7, wherein said score of said comparative analysis is determined as a dot product according to Equations 2.1 and 2.2:
F(x,y)=f(x,y)− f̅ Equation 2.1
T(x,y)=t(x,y)− t̅ Equation 2.2
wherein provided that equations 2.1 and 2.2 are satisfied, said sum of Equation 1 is determined by Equation 3:
$$〈 \frac{F}{‖ F ‖} , \frac{T}{‖ T ‖} 〉 \qquad Equation 3$$
where [symbol] •,• [symbol] is an inner product and ∥•∥ is an L² norm.

8. The system for image processing and verification for a purchase authorization associated with fuel dispensing as in claim 1, wherein said system is characterized by that said graphical user interface is configured to store said at least one image received from said imaging device in said database upon approval of said operator, as a true positive reference, for identification of said vehicle registered to said service of said purchase authorization; thereby extending the variability of a reference base for identification of said vehicle and enhancing a probability of true positive future identifications, by performing an accumulative machine learning over time.

9. The system for image processing and verification for a purchase authorization associated with fuel dispensing as in claim 1, wherein said system is characterized by that said threshold configurator is configured to store said at least one image received from said imaging device in said database upon said score of said comparative analysis exceeding said predefined threshold, as a true positive reference, for identification of said vehicle registered to said service of said purchase authorization; thereby extending the variability of a reference base for identification of said vehicle and enhancing a probability of true positive future identifications, by performing an accumulative machine learning over time.

10. The system for image processing and verification for a purchase authorization associated with fuel dispensing as in claim 1, wherein said system is characterized by that said graphical user interface is configured to store said at least one image received from said imaging device in said database upon denial of said operator, as a true negative reference, for identification of a vehicle other than said vehicle registered to said service of said purchase authorization; thereby enhancing a probability of true negative future identifications, by performing a supervised machine learning over time.

11. A method for image processing and verification for a purchase authorization associated with fuel dispensing, said method comprises:
(a) acquiring at least one image of a fuel inlet of a vehicle registered to a service of said purchase authorization, wherein said at least one image comprises a fuel nozzle of a fuel pump inserted into said fuel inlet of said vehicle;
(b) identifying a registration number of said vehicle registered to said service of said purchase authorization;
(c) retrieving at least one image from a database comprising a plurality of pre-obtained images of said vehicle registered to said service of said purchase authorization, wherein said pre-obtained images comprise a fuel nozzle of a fuel pump inserted into said fuel inlet of said vehicle;
(d) performing a comparative analysis of said at least one image acquired by said imaging device vis-à-vis said at least one pre-obtained image retrieved from said database;
(e) determining a quantitative score of said comparative analysis;
(f) determining whether said quantitative score of said comparative analysis exceeds a predefined threshold;
(g) presenting to an operator said at least one acquired image, wherein said quantitative score of said comparative analysis of said at least one acquired image not exceeding said predefined threshold;
(h) commanding a controller of said fuel pump to dispense said fuel, wherein said quantitative score of said comparative analysis of said at least one acquired image exceeding said predefined threshold.

12. The method of image processing and verification for a purchase authorization associated with fuel dispensing as in claim 11, wherein said acquiring at least one image comprises acquiring a plurality of images obtained by different digital cameras positioned at different locations.

13. The method of image processing and verification for a purchase authorization associated with fuel dispensing as in claim 11, wherein said identifying said registration number of said vehicle registered to said service of said purchase authorization comprises an optical character recognition of a license plate of said vehicle.

14. The method of image processing and verification for a purchase authorization associated with fuel dispensing, as in claim 12, further comprises selecting said at least one acquired image from a plurality of obtained images.

15. The method of image processing and verification for a purchase authorization associated with fuel dispensing as in claim 1, wherein said performing of said comparative analysis of said at least one image acquired by said imaging device vis-à-vis said at least one pre-obtained image retrieved from said database comprises a normalized cross-correlation.

16. The method of image processing and verification for a purchase authorization associated with fuel dispensing as in claim 1, wherein said performing of said comparative analysis of said at least one image acquired by said imaging device vis-à-vis said at least one pre-obtained image retrieved from said database comprises a normalized cross-correlation performed according to Equation 1:
$$\frac{1}{n} {\sum }_{x , y} \frac{( f ( x , y ) - \overline{f} ) ( t ( x , y ) - \overline{t} )}{{σ}_{f} {σ}_{t}} \qquad Equation 1$$
wherein t(x,y) is said acquired image; f(x,y) is said image retrieved from said database; n is a number of pixels in t(x,y) and f(x,y); f̅ is an average of f; t̅ is the average of t; σ_{f} is standard deviation of f and σₜ is standard deviation of t.

17. The method of image processing and verification for a purchase authorization associated with fuel dispensing as in claim 16, wherein said score of said comparative analysis is determined as a dot product according to Equations 2.1 and 2.2:
F(x,y)=f(x,y)− f̅ Equation 2.1
T(x,y)=t(x,y)− t̅ Equation 2.2
wherein provided that equations 2.1 and 2.2 are satisfied, said sum of Equation 1 is determined by Equation 3:
$$〈 \frac{F}{‖ F ‖} , \frac{T}{‖ T ‖} 〉 \qquad Equation 3$$
where [symbol] •,• [symbol] is an inner product and ∥•∥ is an L² norm.

18. The method of image processing and verification for a purchase authorization associated with fuel dispensing as in claim 11, wherein said method is characterized by storing said at least one acquired image in said database upon approval of said operator, as a true positive reference, for identification of said vehicle registered to said service of said purchase authorization; thereby extending the variability of a reference base for identification of said vehicle and enhancing a probability of true positive future identifications, by performing an accumulative machine learning over time.

19. The method of image processing and verification for a purchase authorization associated with fuel dispensing as in claim 11, wherein said method is characterized by storing said at least one acquired image in said database if said score of said comparative analysis exceeds said predefined threshold, as a true positive reference, for identification of said vehicle registered to said service of said purchase authorization; thereby extending the variability of a reference base for identification of said vehicle and enhancing a probability of true positive future identifications, by performing an accumulative machine learning over time.

20. The method of image processing and verification for a purchase authorization associated with fuel dispensing as in claim 1, wherein said method is characterized by storing said at least one acquired image in said database upon denial of said operator, as a true negative reference, for identification of a vehicle other than said vehicle registered to said service of said purchase authorization; thereby enhancing a probability of true negative future identifications, by performing a supervised machine learning over time.
